(19) United States
(12) Patent Application Publication
(10) Pub. No.: US 2019/0231636 A1
(43) Pub. Date: Aug. 1, 2019

(54) Ladder-Style Modular Self-Massage Apparatus

(71) Applicant: GelliFlex Holdings, LLC, Phoenix, AZ (US)

(72) Inventors: Craig Olschansky, Phoenix, AZ (US); Aaron Moncur, Mesa, AZ (US)

(73) Assignee: GelliFlex Holdings, LLC, Phoenix, AZ (US)

(21) Appl. No.: 16/378,390

(22) Filed: Apr. 8, 2019

Related U.S. Application Data
(63) Continuation-in-part of application No. 15/044,113, filed on Feb. 16, 2016, now Pat. No. 10,278,889.
(60) Provisional application No. 62/653,848, filed on Apr. 6, 2018.

(51) Int. Cl. A61H 15/00

(52) U.S. Cl. CPC A61H 15/0092; A61H 2201/0107; A61H 2015/005

(57) ABSTRACT

A self-massage apparatus includes opposed first and second rails, each having a first end, an opposed second end, and a length extending therebetween. A plurality of ball assemblies having opposed first and second ends spans the opposed rails and spaces the first and second rails apart from each other by a fixed distance. Each of the ball assemblies is one of an axle, or an axle, a ball mounted on the axle, and spacers flanking the ball, or an axle and balls mounted on the axle.

### CROSS-REFERENCE TO RELATED APPLICATIONS

This application is a continuation-in-part application of pending U.S. application Ser. No. 15/044,113, filed Feb. 16, 2016, which is hereby incorporated by reference. This application also claims the benefit of U.S. Provisional Application No. 62/653,848, filed Apr. 6, 2018, which is hereby incorporated by reference.

### FIELD OF THE INVENTION

The present invention relates generally to physical therapy, and more particularly to physical therapy self-massage devices.

### BACKGROUND OF THE INVENTION

Millions of people suffer from body pains and discomforts, from general soreness to neuropathy. Treatments range from surgery, to pharmaceutical and naturopathic preparations, to strength and physical therapy, to massage therapy. Massage therapy can be provided by a professional masseuse, but can also be provided by the individual. This is known as self-massage.

Numerous types of massage and self-massage tools exist. However, most suffer from at least several problems. Many self-massage tools rely on hard implements. In what has become known as “trigger-point” massage therapy, self-massage tools are used to relax or release tightness and pain, such as may be caused by friction between muscle fascia or a spasm in muscle tissue. This therapy is often used by athletes and generally relies on very hard implements to apply a large amount of concentrated, focused force on a small, specific area. Such tools are generally not helpful for individuals suffering from neuropathy or for those desiring a more pleasant massage.

Many self-massage tools also require a great deal of force to be effective. Massage tools which require force can be difficult for an individual to use in a self-massage. It is simply just a difficult thing to exert force on one's own body. And, exerting large forces can be painful, causing the individual to abate the force.

Further, many self-massage tools require the individual to assume odd or awkward positions. For instance, to massage one's own calf, an individual has to sit at the end of a surface, such as a coffee table, bend over, and hold an implement behind their own leg while rolling or digging the implement into the calf. This is an awkward position: it can be difficult to breathe because the diaphragm is constricted, blood rushes to the head, and it is hard to reach behind one's own leg. Additionally, for many individuals who suffer from neuropathy, they may have associated ailments which limit their flexibility or ability to hold an uncomfortable position for more than a brief period of time.

Many self-massage tools are very uncomfortable to use; they actually inflict pain before relieving pain. Tools which cause pain are ineffective because their use is frequently abandoned. Individuals would rather live with the mild pain of neuropathy than exert acute pain on themselves.

Still further, many self-massage tools are narrowly focused. They provide one kind of massage, or can only be used in a certain way, or only with a specific body part. An individual who has discomfort all over the body may have to purchase several types of self-massage tools—and use each of them—to alleviate pain.

Clearly, a need for an effective tool for providing a self-massage without the above drawbacks is needed. A tool which is adaptable across a wide range of body parts and body pains and which is used with ease and without pain is desired.

### SUMMARY OF THE INVENTION

A self-massage apparatus includes opposed first and second rails, each having a first end, an opposed second end, and a length extending therebetween. A plurality of ball assemblies having opposed first and second ends spans the opposed rails and spaces the first and second rails apart from each other by a fixed distance. Each of the ball assemblies is one of an axle, or an axle, a ball mounted on the axle, and spacers flanking the ball, or an axle and balls mounted on the axle.

The above provides the reader with a very brief summary of some embodiments discussed below. Simplifications and omissions are made, and the summary is not intended to limit or define in any way the scope of the invention or key aspects thereof. Rather, this brief summary merely introduces the reader to some aspects of the invention in preparation for the detailed description that follows.

### BRIEF DESCRIPTION OF THE DRAWINGS

Referring to the drawings:

FIG. 1 is a top perspective view of an embodiment of a modular self-massage apparatus;

FIGS. 2A and 2B are top perspective section views of the apparatus of FIG. 1, taken along the line 2-2 in FIG. 1;

FIG. 3A is a top perspective, exploded view of the apparatus of FIG. 1;

FIG. 3B is an enlarged view of a cradle of the apparatus of FIG. 1;

FIGS. 4A-4C are top perspective views of other embodiments of modular ball assemblies for use in the apparatus of FIG. 1;

FIG. 4D is a top perspective, exploded view of the ball assembly of FIG. 4A;

FIG. 4E is a top perspective, exploded view of the ball assembly of FIG. 4C;

FIGS. 4F and 4G are top perspective, exploded views of still other embodiments of modular ball assemblies for use in the apparatus of FIG. 1;

FIGS. 4H and 4I are top perspective views of yet still other embodiments of modular ball assemblies for use in the apparatus of FIG. 1;

FIG. 4J is a top perspective view of an embodiment of a ball for use in any of the ball assemblies of FIGS. 4A-4I;

FIGS. 5A-5C are top, side, and front perspective views of another embodiment of a modular self-massaging apparatus;

FIG. 6 is a side perspective view of yet another embodiment of a modular self-massaging apparatus;

FIGS. 7 and 8 are top perspective and exploded perspective views of an embodiment of a ladder-style modular self-massage apparatus;

FIGS. 9 and 10 are top perspective and exploded perspective views of an embodiment of a ladder-style modular self-massage apparatus;

FIGS. 11 and 12 are top perspective and exploded perspective views of an embodiment of a ladder-style modular self-massage apparatus;

FIGS. 13 and 14 are top perspective and exploded perspective views of an embodiment of a ladder-style modular self-massage apparatus;

FIGS. 15 and 16 are top perspective and exploded perspective views of an embodiment of a ladder-style modular self-massage apparatus;

FIGS. 17 and 18 are top perspective and exploded perspective views of an embodiment of a ladder-style modular self-massage apparatus;

FIGS. 19 and 20 are top perspective and exploded perspective views of an embodiment of a ladder-style modular self-massage apparatus;

FIGS. 21 and 22 are top perspective and exploded perspective views of an embodiment of a ladder-style modular self-massage apparatus;

FIGS. 23 and 24 are top perspective and exploded perspective views of an embodiment of a ladder-style modular self-massage apparatus; and

FIGS. 25 and 26 are top perspective and exploded perspective views of an embodiment of a ladder-style modular self-massage apparatus.

### DETAILED DESCRIPTION

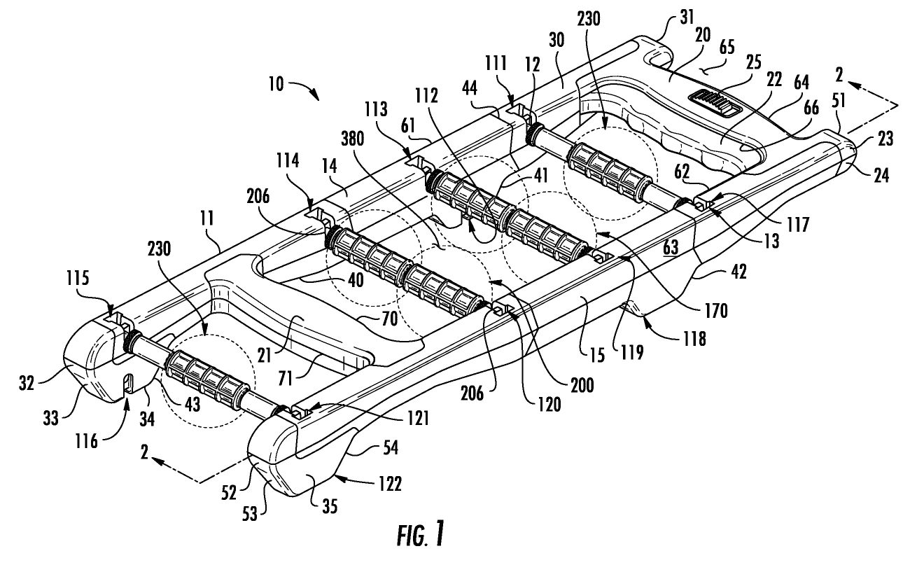

Reference now is made to the drawings, in which the same reference characters are used throughout the different figures to designate the same elements. Reference now is made to the drawings, in which the same reference characters are used throughout the different figures to designate the same elements. FIG. 1 illustrates a modular self-massage apparatus 10 (hereinafter the “apparatus 10”) useful for providing soft-tissue and therapeutic relief to individuals. The apparatus 10 allows an individual to give himself a productive, varied, and specific soft massage by providing him with a tool that can be configured in a plurality of disparate arrangements, each defining and allowing a different massage technique, for a different part of the body, with a different type of leverage. The apparatus 10 thus is a unique and effective mechanism for an individual to soothe many different parts of the body with a single tool.

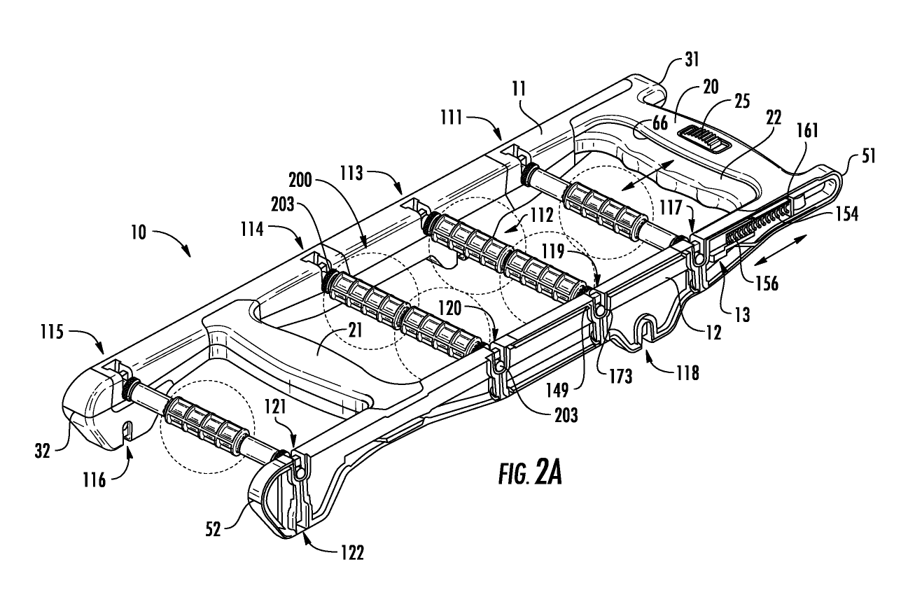

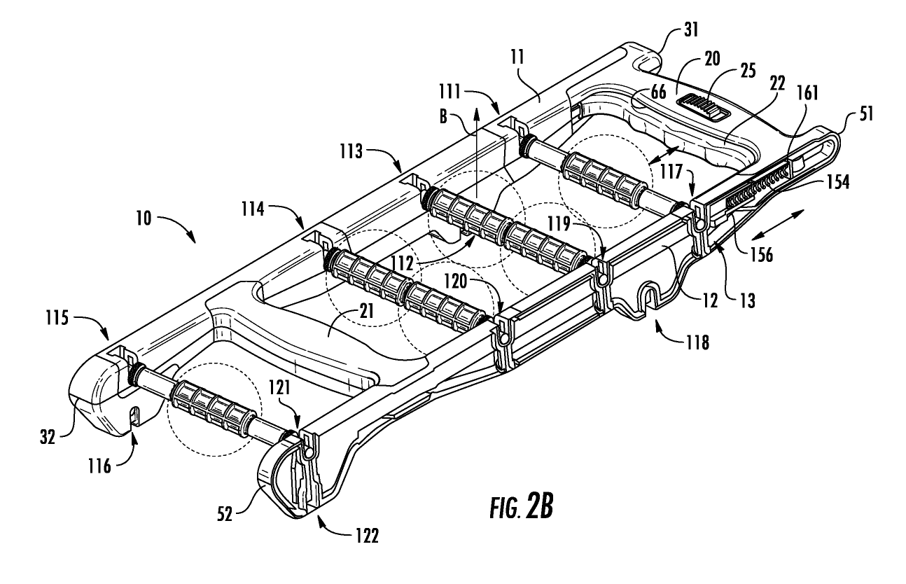

The apparatus 10 includes an external framework 11 carrying a predominantly internal chassis rail 12 (better seen in FIGS. 2A and 2B). The framework 11 and chassis rail 12 cooperate to form capture means, or cradles 13, across the apparatus 10 in which ball assemblies can be secured and carried. Though the ball assemblies are explained in detail later, it is briefly worth noting that the ball assemblies are modular; each can be disassembled and reassembled to form a different type of ball assembly. Modularity is achieved because each ball assembly, while unique, relies on similar or identical constituent parts, such as an axle. And the axle, for example, is dropped into the cradles 13 as desired for free rotation therein, thus allowing the individual to change and customize the apparatus for different massages.

The framework 11 includes opposed side members 14 and 15, which are referred to herein for convenience purposes only as a left side member 14 and a right side member 15. The left side member 14 is elongate and relatively thin and short. The right side member 15 is similarly elongate and relatively thin and short. Indeed, the left and right side members 14 and 15 are identical but opposite in orientation on the framework 11, mirrored about a centerline extending therebetween. The left and right side members 14 and 15 are spaced apart from each other, are parallel with respect to each other, and, in this parallel fashion, are disposed in the same plane such that their tops are coplanar. The left and right side members 14 and 15 are available to be gripped by hand nearly anywhere along their entire lengths, so as to provide varied and unique hand angles to exert similarly varied and unique forces. Further, portions of the framework 11 are soft, covered, or over-molded to provide a comfortable and tacky location to be gripped.

The left and right side members 14 and 15 are spaced apart by two braces 20 and 21. The braces 20 and 21 define grips, or handles, serving not only to space the left and right side members 14 and 15 apart, but also to provide additional gripping and fulcrum locations for an individual. The brace 20 further includes a location at which a trigger 22 is exposed outside of the brace 20; the trigger 22 is operatively coupled to the chassis rail 12 to move the chassis rail 12 between open and closed positions, as is later described.

In the embodiment depicted in FIG. 1, the framework 11 appears bifurcated between a single top half 23 and a single bottom half 24. Indeed, in a preferred embodiment, the framework 11 is constructed from as few pieces as possible to provide strength and rigidity to the apparatus 10. However, it has been found that an adequately durable, strong, and rigid apparatus 10 can be constructed with a two-piece framework 11 formed from the top half 23 and the bottom half 24 fastened together with screws, bolts, sonic welding, or like fastening method. It should be noted that although the terms “top half 23” and “bottom half 24” are used to describe portions of the framework, those portions are not true halves of a whole; they are not equal in size. The framework is constructed from a material or combination of materials having the material characteristics of low density, high rigidity, high tensile strength, high compressive strength, and durability, such as plastic. The braces 20 and 21 are formed integrally and monolithically to the left and right side members 14 and 15, though in some embodiments, for ease of manufacturing, the braces 20 and 21 are separate pieces fastened to the left and right side members 14 and 15.

The left side member 14 includes a top surface 30, which extends entirely across the right side member 15 and the braces 20 and 21. The top surface 30 is generally flat and straight, and uniquely extends in a single plane from the left side member 14, across the right side member 15, the brace 20, and the brace 21, so that the left and right side members 14 and 15 and the braces 20 and 21 terminate upwardly at a common flat surface. The flat top surface 30 allows the apparatus 10 to be flipped and placed on the ground with its top surface 30 down for a variety of massages in this orientation. The left side member 14 has a first end 31 and an opposed second end 32. As is seen in FIG. 1, the first end 31 is semi-circular, oriented transverse to the length of the left side member 14 and laterally away from the left side member 14. The first end 31 has an arcuate transition from the top surface 30. The second end 32 is quasi-semi-circular, and is also oriented transverse to the length of the left side member 14 and laterally away from the left side member 14, but is directed opposite to the first end 31. Further, the second end 32 has only approximately a 120 degree arcuate transition from the top surface 30, and then transitions to a diagonal but flat face 33 which defines part of a major foot 34 proximate to the second end 32. An opposed major foot 35 is formed on the right side member 15. The framework 12 around the major feet 32 and 52 is formed of, or more preferably covered in, a material having a soft and tacky characteristic. This provides both a soft and comfortable grip as well a secure, non-slip grip.

The left side member 14 further includes a bottom surface 40, which extends entirely between the ends 31 and 32. Like the top surface 30, the bottom surface 40 is common to the right side member 15 and the braces 20 and 21, but the bottom surface is curvilinear and does not lie in a single, flat plane. Cooperating with the top surface 30, the bottom surface 40 defines a thickness—in the vertical direction—of the left side member 14. Briefly, it is noted that the term “vertical” as used herein will refer to a direction on the apparatus 10 which extends from the bottom surface 40 to the top surface 30, or in the same direction as the reference characters. “Horizontal” or “lateral” will refer to a direction perpendicular to vertical, or extending along or between the left and right side members 14 and 15. Returning to the description of the thickness of the left side member 14, that thickness varies between the ends 31 and 32. Proximate to the first end 31, the bottom surface 40 is generally straight and parallel with respect to the top surface 30; thus, the left side member 14 has a generally constant thickness proximate to the first end 31. Between braces 20 and 21, however, the left side member 14 is formed with a minor foot 41 (an opposite minor foot 42 is formed on the right side member 15, as well). A portion of the left side member 14 around the minor foot 41 is formed of, or covered in, a material having a soft and tacky characteristic. This provides both a soft and comfortable grip as well a secure, non-slip grip. This portion is identified with the reference character 44. The minor foot 41 bounds and defines a well internal to the framework 11. The bottom surface 40 of the left side member slopes downward to this minor foot 41, and so the left side member 14 has an increasing thickness from the first end 31 to the minor foot 41. From the minor foot 41 to the brace 21, the bottom surface 40 slopes generally upward, and the thickness of the left side member 14 decreases from the minor foot 41 to the brace 21. The thickness of the left side member 14 at the brace 21 is approximately equal to the thickness of the left side member 14 proximate to the first end 31. The bottom surface 40 then cuts sharply downward to the major foot 34, with a diagonal but flat face 43 which defines a part of the major foot 34 proximate to the second end 32. Both the first and second ends 31 and 32 have a tacky material characteristic.

Referring still to FIGS. 1, 2A, and 2B, the right side member 15 is similar to the left side member 14. The top and bottom surfaces 30 and 40 of the left side member 14 are common to the right side member 15, and so reference to them will include specific identification in context of the right side member 15 to avoid confusion. Along the right side member 15, the top surface 30 is generally flat and straight, and extends from a first end 51 of the right side member 15 to an opposed second end 52 of the right side member 15. The first end 51 is semi-circular, oriented transverse to the length of the right side member 15 and laterally away from the right side member 15. The first end 51 has an arcuate transition from the top surface 30. The second end 52 is quasi-semi-circular, and is also oriented transverse to the length of the right side member 15 and laterally away from the right side member 15, but is directed opposite to the end 51. Further, the end 52 has only approximately a 120 degree arcuate transition from the top surface 30, and then transitions to a diagonal, but flat face 53 which defines part of the major foot 35 proximate to the end 52 and opposed from the major foot 34. Both the first and second ends 51 and 52 have a tacky material characteristic.

The bottom surface 40 of the right side member 15 is curvilinear and does not lie in a single, flat plane. Cooperating with the top surface 30, the bottom surface 40 along the right side member 15 defines a vertical thickness of the right side member 15. That thickness varies between the ends 51 and 52. Proximate to the end 51, the bottom surface 40 along the right side member 15 is generally straight and parallel with respect to the top surface 30; thus, the right side member 15 has a generally constant thickness proximate to the end 51. Between braces 20 and 21, however, the right side member 15 is formed with the minor foot 42. The bottom surface 40 along the right side member 15 slopes downward to this minor foot 42, and so the right side member 15 has an increasing thickness from the end 51 to the minor foot 42. A portion of the right side member 15 around the minor foot 42 is formed of, or covered in, a material having a soft and tacky characteristic. This provides both a soft and comfortable grip as well a secure, non-slip grip. The minor foot 42 defines an internal well within the framework 11, as will be explained later. From the minor foot 42 to the brace 21, the bottom surface 40 along the right side member 15 slopes generally upward, and the thickness of the right side member 15 decreases from the minor foot 42 to the brace 21. The thickness of the right side member 15 at the brace 21 is approximately equal to the left side member 14 at the brace 21, and also to the thickness of the right side member 15 proximate to the end 51. The bottom surface 40 along the right side member 15 then cuts sharply downward to the major foot 35, with a diagonal but flat face 54 which defines a part of the major foot 35 proximate to the end 52.

The left side member 14 includes opposed inner and outer surfaces 60 and 61, which are flat, generally smooth, and parallel to each other. The right side member 15 also includes opposed inner and outer surfaces 62 and 63, which are flat, generally smooth, and parallel to each other. The inner surfaces 60 and 62 are directed toward each other and are parallel, and the outer surfaces 61 and 63 are directed away from each other and are parallel. The inner surfaces 60 and 62 and the outer surfaces 61 and 63 are split between the upper and lower halves 23 and 24, though the upper and lower halves 23 and 24 are seated against each other smoothly such that there is only a very small, minor seam extending across the inner surfaces 60 and 62 and the outer surfaces 61 and 63.

With reference to FIG. 1, the brace 21 extends between the left and right side members 14 and 15. The brace 21 defines a fulcrum, which can be used against the inside of an individual's elbow, or gripped in the individual's hand, when the brace 21 is gripped, so as to provide increased, leveraged force on a body part if so needed. The brace 21 is a fulcrum because it provides a pivot point about which the apparatus 10 can be moved during a massage. The brace 21 includes the top surface 30 which extends across it from the left side member 14 to the right side member 15, and the bottom surface 40, which similarly extends across it between the left and right side members 14 and 15. The brace 21 includes opposed inner and outer faces 70 and 71, each of which defines a fulcrum face in that each can be used as the face against which—or about which—the apparatus 10 pivots. The brace 21 is formed of, or covered in, a material having a soft and tacky characteristic. This provides both a soft and comfortable grip as well a secure, non-slip grip.

The brace 20 extends between the left and right side members 14 and 15 proximate to the ends 31 and 51. The brace 20 defines a fulcrum, which can be used against the inside of an individual's elbow when the brace 21 or some other part of the apparatus 10 is gripped to provide increased, leveraged force on a body part if so desired. The brace 20 is a fulcrum because it provides a pivot point about which the apparatus 10 can be moved during a massage. The brace 20 includes the top surface 30 which extends across it from the left side member 14 to the right side member 15, and the bottom surface 40, which similarly extends across it between the left and right side members 14 and 15. The brace 20 includes a side face 64, which defines an outer fulcrum face, directed away from the majority of the framework 11. The left and right side members 14 and 15 extend only slightly past the side face 64 of the brace 20 to their ends 31 and 51, thereby bounding and defining an open, U-shaped pocket 65 between the ends 31 and 51 and the side face 64. The side face 64 is slightly convex, bowing outward from the left and right side members 14 and 15. Opposite the side face 64 is a slot 66 formed in the brace 20. The slot 66 extends entirely from the left side member 14 to the right side member 15 and opens vertically between the top and bottom surfaces 30 and 40. The slot 66 extends entirely into the brace 20, and is occupied by the trigger 22. The brace 21, like the brace 20, is formed of, or covered in, a material having a soft and tacky characteristic. This provides both a soft and comfortable grip as well a secure, non-slip grip.

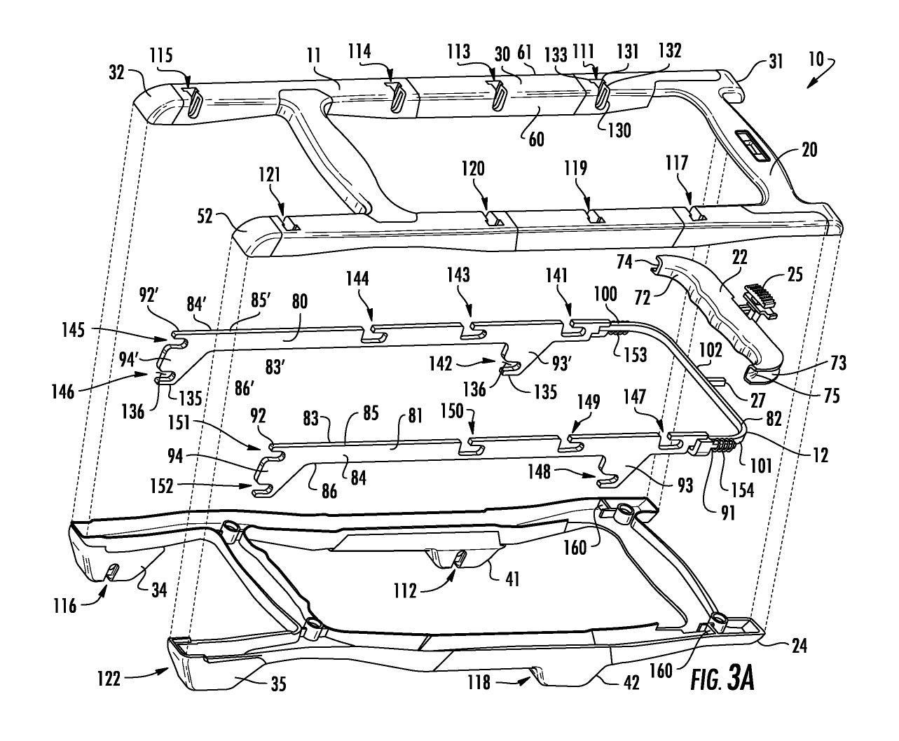

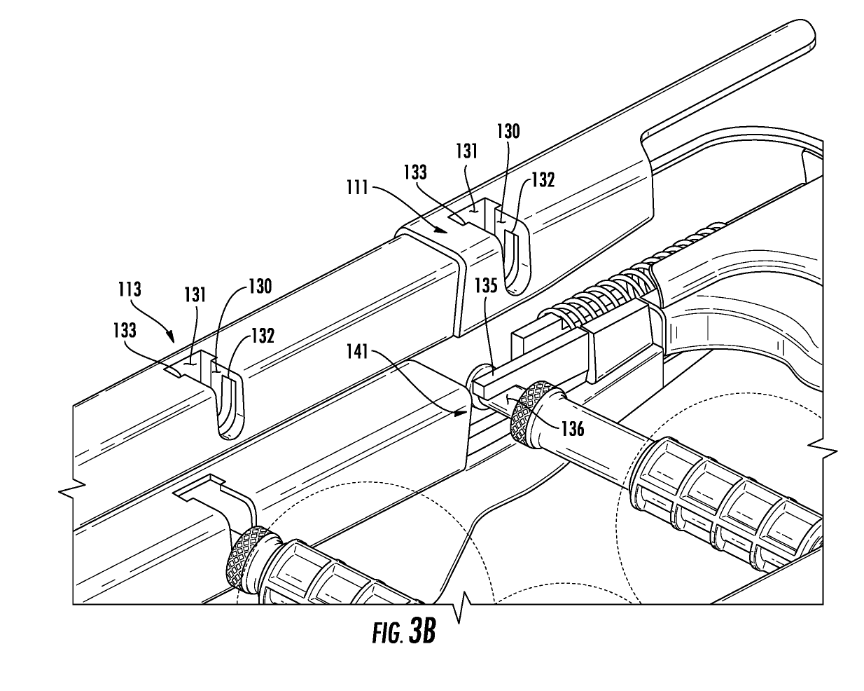

Turning now to FIG. 3A, in addition to FIG. 1, the trigger 22 is a cover that fits over the chassis 12. The trigger 22 is a concave grip having a solid front face 72 and an opposed, open-backed channel 73 into which the chassis rail 12 is seated. The front face 73 has a number of depressions or stalls for receiving fingers when gripped. The channel 73 is wide and coextensive in width with the brace 20, and turns forward at opposed ends 74 and 75 to provide the trigger 22 with its concave shape. The trigger 22 is mounted on the chassis rail 12 and moves between an extended position, shown in FIG. 2A, and a retracted position, shown in FIG. 2B, to impart movement to the chassis rail 12, according to description below.

The apparatus 10 is formed with a safety lock 25, which is a slidable button carried in the brace 20 for reciprocal movement between the left and right side members 14 and 15. The safety lock 25 has a block 26 which depends from the lock 25 into the brace 20. The block 26 is formed with a slotted keyway aligned parallel to the direction of movement of the trigger 22. The chassis rail has a key 27 extending rearwardly. The key 27 is aligned with the block. When the safety lock 25 is slid to one side in a locked position, the key 27 is registered with the block 26. When the safety lock 25 is slid to the other side in an unlocked position, the key 27 is registered with the keyway in the block 26. In the locked position of the safety lock 25, the trigger 22 is prevented from being drawn back: the key 27 encounters the block 26 and is prevented from moving. In the unlocked position of the safety lock 25, the trigger 22 can move back: the key 27 is registered with the keyway and slides into the keyway as the trigger 22 and chassis rail 12 are moved back into the brace 20.

The trigger 22 is fit over and receives a portion of the chassis rail 12. The chassis rail 12 is best seen in the exploded view of FIG. 3A; it extends internally throughout much of the framework 11. The chassis rail 12 has a unique structure to fit within the framework 11 and cooperate with the framework 11 to form the cradles 13 in which the ball assemblies can be received, secured, and released. The chassis rail 12 includes opposed, elongate, left and right rail members 80 and 81 and a tie or bridge 82 extending between the rail members 80 and 81. Preferably, the chassis rail 12 is constructed from a single piece of material, such as plastic and metal, and is formed in a mold such as an injection mold, or is die cut, or is stamped and bent. In some embodiments, however, the left and right rail members 80 and 81 are separate, as is the bridge 82 which is coupled to the rail members 80 and 81.

The rail members 80 and 81 are opposite and identical, and as such, only one will be described here, with the understanding that the description applies equally to the other, except as specifically identified herein. The description will thus treat the right rail member 81, illustrated in the foreground of FIG. 3A. The same reference characters are used to designate the same structural features and elements of the left and right rail members 80 and 81, but the structural features and elements of the left rail member 80 are marked with a prime symbol (“′”) so as to clearly differentiate them from those of the right rail member 81. The right rail member 81 has opposed inner and outer faces 83 and 84, which are major faces and larger than a top edge 85 and an opposed bottom edge 86. The inner and outer faces 83 and 84 and the top and bottom edges 85 and 86 cooperate to define a body of the right rail member 81. The right rail member 81 extends between a first end 91 and a second end 92, the distance between which is just less than the distance between the first and second ends 51 and 52 of the right side member 15 of the framework 11.

The top edge 85 is generally straight but for a plurality of notches formed into the body of the right rail member 81. The bottom edge 86 is not so configured; proximate to the first end 91, it extends straight and parallel to the top edge 85 and then turns downward at a projection 93 extending down from the top edge 85. The projection 93 corresponds to the minor foot 42. The projection 93 includes a notch. The bottom surface 86 then moves upward and turns rearward to progress straight and parallel to the top edge 85 until the second end 92, where another projection 94 is formed. The projection 94 at the second end 92 corresponds to the major foot 35 in the right side member 15 of the framework 11, and extends downward roughly the same vertical distance as the projection 92, and it includes two notches. Thus, the right rail member 81 has a vertical height which varies between the first and second ends 91 and 92, from relatively short at the first end 91 to tall at the projection 93 to short again between the projections 93 and 94 to finally tall at the projection 94.

As stated above, and still referring to FIG. 3A, the left and right rail members 80 and 81 have identical structural features and elements, but those of the left rail member 80 are designated with the prime symbol and not necessarily marked on the drawings for the sake of the clarity of the illustration. As such, the left rail member 80 includes an inner face 83′, an outer face 84′, a top edge 85′, a bottom edge 86′, first and second ends 91′ and 92′, and two projections 93′ and 94′.

The bridge 82 between the left and right rail members 80 and 81 connects the left and right rail members 80 and 81 rigidly so that the left and right rail members 80 and 81 move together in unison and do not flex, slide, or otherwise move independently of each other. The bridge 82 is U-shaped, and has opposed legs 100 and 101 and a back 102 extending therebetween. The legs 100 and 101 are integrally formed to the left and right rail members 80 and 81, in embodiments in which the chassis rail 12 is a monolithic structure. In embodiments in which the chassis rail 12 is assembled from separate pieces, the legs 100 and 101 are fixed and secured, such as with fasteners, welding, sonic welding, or other similar permanent fastening method. The legs 100 and 101 are short in comparison to the wide back 102. The key 27 for preventing the movement of the trigger 22 extends centrally from the back 102 toward the keyway formed in the block 26.

As has been stated above, the framework 11 and the chassis rail 12 cooperate to form a plurality of cradles across the apparatus 10. Returning to FIG. 1, a number of cradles are seen formed into the left side member 14; similar cradles are formed into the right side member 15 in opposing locations as sets or pairs. Each of the locations of the cradles is specific, so as to provide the apparatus 10 with a plurality of unique, disparate arrangements for the ball assemblies. First, third, fourth, and fifth cradles 111, 113, 114, and 115 are formed into the top surface 30 of the left side member 14 and are directed upward to receive a ball assembly from above. Second and sixth cradles 112 and 116 are formed into the bottom surface 31 of the left side member 14 and are directed downward. The first cradle 111 is formed proximate to the first end 31. The second cradle 112 is formed in the minor foot 41. The third cradle 113 is formed just above the minor foot 41. The fourth cradle 114 is formed between the minor foot 41 and the brace 21. The fifth cradle 115 is formed above the major foot 34, and the sixth cradle 116 is formed in the major foot 34. Each of the cradles 111-116 extends into the framework 11 from the inner surface 60 and either of the top surface 30 or the bottom surface 31. The cradles all extend in from the inner surface 60 because the ball assemblies span between the left and right side members 14 and 15 and thus engage with the framework 11 through the inner surface 60.

A number of cradles are formed into the right side member 15. Each corresponds with a cradle formed into the left side member 14, forming a set therewith. Seventh, eighth, ninth, tenth, eleventh, and twelfth cradles 117, 118, 119, 120, 121, and 122 are formed into the right side member 15 and are directed upward to receive a ball assembly therein from above. Eighth and twelfth cradles 118 and 122 are directed downward to receive a ball assembly therein from below. The seventh cradle 117 is formed proximate to the first end 51. The eighth cradle 118 is formed in the minor foot 42. The ninth cradle 119 is formed just above the minor foot 42. The tenth cradle 120 is formed between the minor foot 42 and the brace 21. The eleventh cradle 121 is formed just above the major foot 35. The twelfth cradle 122 is formed in the major foot 35. The eighth and ninth cradles 118 and 122, formed in the minor and major feet 34 and 35, respectively, are not visible in FIG. 1, but the reference characters and arrows show the general location, and one having ordinary skill in the art will readily appreciate and understand that the eighth and ninth cradles 118 and 122 are formed into the minor and major feet 42 and 35 identically and oppositely as the twelfth and sixteenth cradles are formed into the minor and major feet 41 and 34 of the left side member 14.

Each of the cradles 117-122 extends into the framework 11 from inner surface 62 and either the top surface 30 or the bottom surface 31. The cradles 117-122 all extend in from the inner surface 62 because the ball assemblies span between the left and right side members 14 and 15 and thus engage with the framework 11 through the inner surface 62. To accommodate and position the ball assemblies, the cradles are arranged in sets or pairs; each pair includes two oppositely-set cradles. Thus, the first and seventh cradles 111 and 117 form a pair, the second and eighth cradles 112 and 118 form a pair, the third and ninth cradles 113 and 119 form a pair, the fourth and tenth cradles 114 and 120 form a pair, the fifth and eleventh cradles 115 and 121 form a pair, and the sixth and twelfth cradles 116 and 122 form a pair.

The cradles are each identical, though located and oriented differently. Referring now primarily to FIG. 3B, the cradles are formed by the framework 11 and the chassis rail 12. The first cradle 111 includes a vertical notch extending downward from the top 30 and through the inner surface 60, terminating a point just above halfway between the top and bottom surfaces 30 and 40. The first cradle 111 is blind to the outer surface 61; it does not pass through or extend to the outer surface 61. The first cradle 111 includes a narrow inner portion 130 formed through the inner surface 60 and an enlarged head 131 inboard of the inner portion 130. The inner portion 130 further includes an axial slot 132 extending lengthwise through the inner portion 130 along a line oriented between the first end 31 and the second end 32. The slot 132 defines an opening for the chassis rail 12 to pass through the first cradle 111, as will be explained. The first cradle 111 is oriented vertically, such that a ball assembly is applied from the top down into the first cradle 111. An outwardly-directed shoulder 133 is defined laterally from the enlarged head 131 to the inner portion 130. The shoulder 133 is a horizontal transition between the larger diameter enlarged head 131 and the smaller diameter inner portion 130. The shoulder 133 further defines an abutment surface.

The chassis rail 12 has a guard 141 which interacts with the first cradle 111 to secure and release a ball assembly. With reference still to FIG. 3B, the guard 141 is formed from a channel cut into the top edge 85′ of the left rail member 80 which then turns laterally and cuts along the length of the left rail member 80 between the top and bottom edges 85′ and 86′, thus defining a jaw 135 and a catch 136 below the jaw 136. Positioned in the framework 11, the guard 141 extends through the first cradle 111, and is moveable in a reciprocating fashion to slide the jaw 135 into and back out of the slot 132, thereby closing and opening the first cradle 111, respectively.

Referring again to FIG. 3A, each of the cradles depending from the top surface 30 of the framework 11 is identical to the first cradle 111. Each of the third cradle 113, fourth cradle 114, fifth cradle 115, seventh cradle 117, ninth cradle 119, tenth cradle 120, and eleventh cradle 121 depend from the top surface 30. Each has the same inner portion 130, enlarged head 131, slot 132, and shoulder 133 as the first cradle 111, and as such, description of each will not be presented here. One having ordinary skill in the art will readily appreciate and understand how such structure is formed and used for the third cradle 113, fourth cradle 114, fifth cradle 115, seventh cradle 117, ninth cradle 119, tenth cradle 120, and eleventh cradle 121. The reference characters 130-136 are not shown in the drawings for those cradles other than the first cradle 111 for cleanliness of the drawings.

Further, the second and sixth cradles 112 and 116 have the identical structure as the first cradle 111 as well, but such structure is flipped in orientation about a horizontal. The second and sixth cradles 112 and 116 each have an inner portion 130, an enlarged head 131, a slot 132, and a shoulder 133, though those numbers are not marked on the drawings for the sake of cleanliness. Like in the first cradle 111, the inner portion 130 of the second cradle 112 is formed through the inner surface 60 and next to the enlarged head 131. However, unlike in the first cradle 111, the inner portion 130 of the second cradle 112 is formed into the framework 11 from the bottom surface 40 of the minor foot 41, and its orientation is thus reversed with respect to the first cradle 111. The sixth cradle 116 is formed and oriented similarly to the second cradle, though in the major foot 34 rather than the minor foot 41. Similarly, the eighth and twelfth cradles 118 and 122 have identical structure as the second and sixth cradles 112 and 116, being formed in the minor and major feet 42 and 35, respectively, but in an opposite orientation on the right side member 15 instead of the left side member 14.

Moreover, there are a number of guards formed across the chassis rail 12. The guard 141 is a first guard 141 corresponding to the first cradle 111. There also is a second guard 142 corresponding to the second cradle 113, a third guard 143 corresponding to the third cradle 113, a fourth guard 144 corresponding to the fourth cradle 114, a fifth guard 145 corresponding to the fifth cradle 115, a sixth guard 146 corresponding to the sixth cradle 116, a seventh guard 147 corresponding to the seventh cradle 117, an eighth guard 148 corresponding to the eighth cradle 118, a ninth guard 149 corresponding to the ninth cradle 119, a tenth guard 150 corresponding to the tenth cradle 120, an eleventh guard 151 corresponding to the eleventh cradle 121, and a twelfth guard 152 corresponding to the twelfth cradled 112. Each of the guards is located through the slot 132 of its corresponding cradle to form a cradle assembly. Each of these guards 142-152 includes the identical structure of the first guard, namely, a jaw 135 and a catch 136.

While most of the guards are formed in-line with the generally straight chassis rail 12, four guards are not. The second guard 142 is formed on the projection 93′, the sixth guard 146 is formed on the projection 94′, the eighth guard 148 is formed on the projection 93, and the sixth twelfth guard 152 is formed on the projection 94. The second and eighth guards 142 and 148 are identical, formed on opposed projections 93′ and 93, respectively. The second guard 142 includes a jaw 135 which defines the lower end of the projection 93′, and a catch 136 is just above it, extending into the projection 93′ from a vertical rear face thereof. The projection 93 has in the second guards 142 similar structure to eighth cradle 148. The sixth and twelfth guards 146 and 152 are identical, formed on opposed projections 94′ and 94, respectively. The sixth guard 146 includes a jaw 135 formed at and defining the lower end of the projection 94′ and a catch 136 just above it, extending in to the projection 94′ from a vertical rear face. Similarly, the fifth guard 145 extends into the projection 94′ from the same vertical face. The projection 94 has in the eleventh and twelfth guards 151 and 152 similar structure to both the fifth and sixth cradles 145 and 146.

The chassis rail 12 is carried in the framework 11 for sliding, reciprocal movement within the framework 11. As seen in FIG. 3A, two springs 153 and 154 are carried on a portion of the chassis rail 12 and bias it into an extended position. The springs 153 and 154 can be compressed to place the chassis rail 12 in a retracted position. The chassis rail 12 includes two posts 155 and 156 which are coupled to the chassis rail 12 generally between the left rail member 80 and the bridge 82 and between the right rail member 81 and the bridge 82. The posts 155 and 156 are short projections or stubs extending toward the first ends 31 and 51, and the springs 153 and 154 are placed onto them. The springs are compressed between the bases of the posts 155 and 156 and two abutment surfaces 160 and 161 within the framework 12. The abutment surfaces 160 and 161 are internal walls that limit the movement of the compression springs 153 and 154 and the sliding movement of the chassis rail 12. Referring now to FIGS. 2A and 2B, which are section views taken along the line 2-2 in FIG. 1, the two positions of the chassis rail 12 are illustrated. FIG. 2A illustrates the extended position of the chassis rail 12, while FIG. 2B illustrates the retracted position of the chassis rail 12.

In FIG. 2A, the trigger 22 is in an extended position. The bridge 82 of the chassis rail 12 is seated into the channel 73 of the trigger 22, thereby coupling the trigger 22 to the chassis rail 12 so that the two move together in synchronous motion. The trigger 22 may in some cases be bonded or adhered to the chassis rail 12 to further secure the coupling between the trigger 22 and the chassis rail 12. When the trigger 22 is in an extended position as in FIG. 2A, the trigger 22 is moved out of the slot 66, toward the brace 20. This occurs when an individual releases the trigger 22, such as would occur when the individual is actively using the apparatus 10 for a massage or the apparatus 10 is stored. The springs 153 and 154, riding on the posts 155 and 156, respectively, are slightly compressed between the bases of the posts 155 and 156 and the abutment faces 160 and 161, respectively, and thus exert an axial force against the chassis rail 12, urging the chassis rail 12 toward the brace 21. When the chassis rail 12 is so urged, each of the cradles 111-122 is closed, because each of the guards 141-152 is moved forward and the jaws 135 are in the slots 132 of the cradles 111-122. The jaws 135 penetrate through the slots 132 to close the cradles 111-122.

FIG. 2B, on the other hand, shows the chassis rail 12 slid back. The trigger 22 is compressed, such as would occur when an individual grips the trigger 22 together with the brace 20 and draws the trigger 22 back against the resistance of the springs 153 and 154. When the trigger 22 is compressed, it is moved into the slot 66, toward the brace 20. The chassis rail 12, being seated in the trigger 22, is moved in the same direction, toward the brace 20. The springs 153 and 154 are greatly compressed, and the posts 155 and 156 which the springs 153 and 154 ride on may in some cases contact or “bottom out” against the abutment faces 160 and 161, respectively. The springs 153 and 154 resist the compression, exerting a force on the chassis rail 12 toward the brace 21. When the chassis rail 12 is moved in this direction toward the brace 20, each of the cradles 111-122 is simultaneously opened and open, because each of the guards 141-152 is moved backward and the jaws 135 are out of the slots 132 of the cradles 111-122. In this way, each of cradles 111-122 has an opening through which a ball assembly can be applied to place the ball assembly in the cradle 111-122.

A unique characteristic of the apparatus 10 is its modularity. The apparatus 10 is used with a large variety of ball assemblies, each of which presents a different massage surface and can be arranged in a different location to provide the individual with a different massage experience. Each of the seven ball assemblies described below is modular, in that each can be disassembled into basic constituent parts such as axles, nuts, and ball units. Those constituent parts can be rearranged in different combinations and permutations to form different assemblies. The seven ball assemblies presented below offer many different assemblies. It is noted, however, that each of the below seven embodiments has a “fixed” analog in which the constituent parts are integral parts or are fixed together. In this fixed analog, the axle, nuts, hubs, and balls are formed integrally and monolithically as a single piece, so that an individual can purchase and apply a pre-assembled ball assembly without having to assemble or build it.

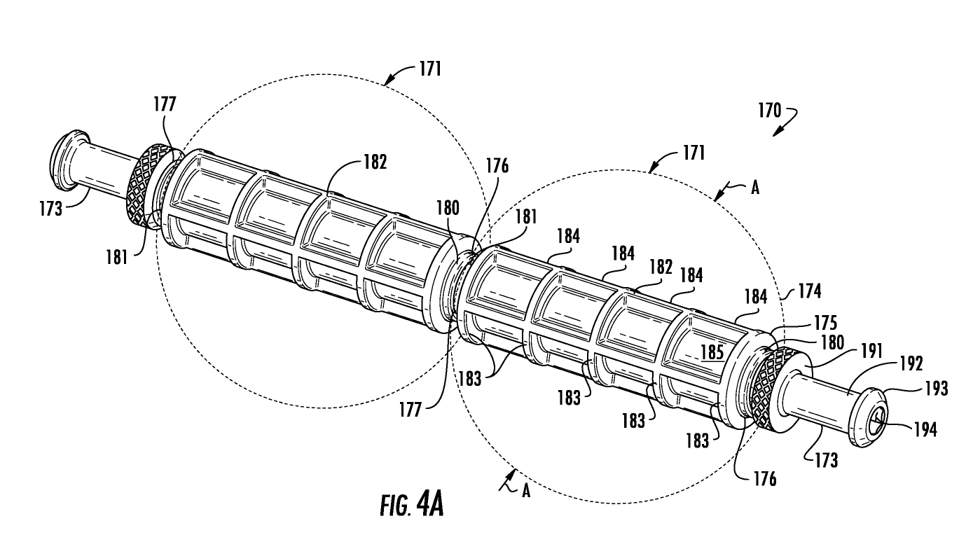

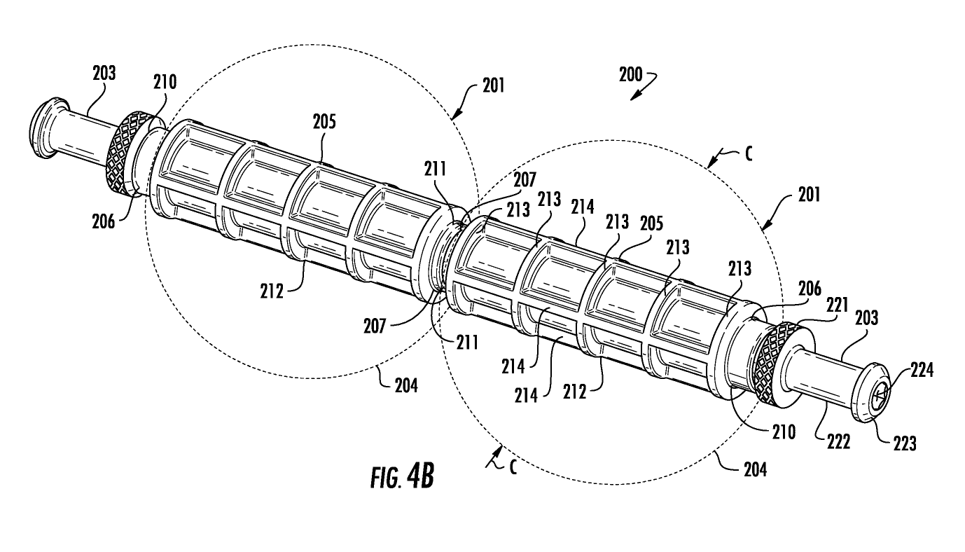

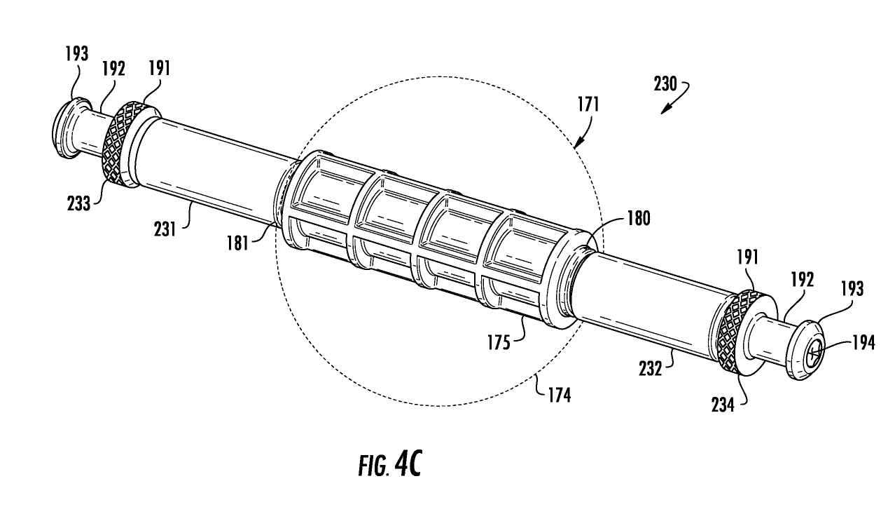

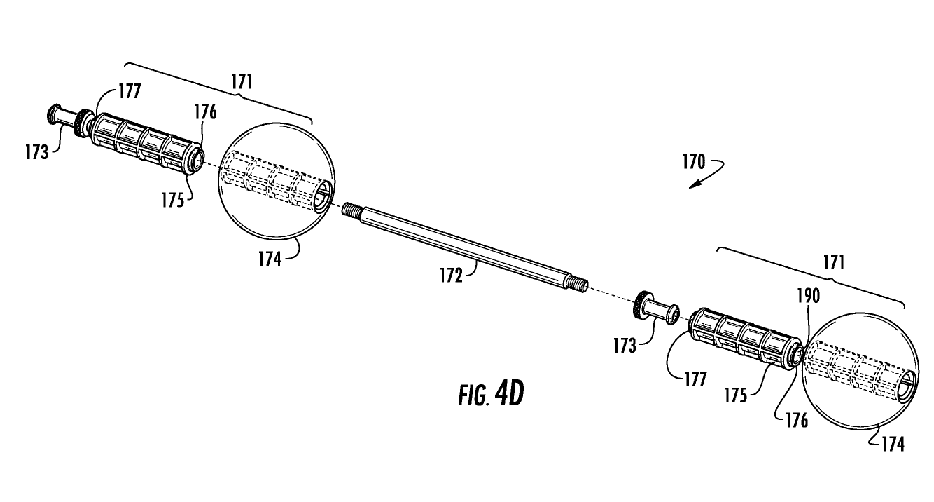

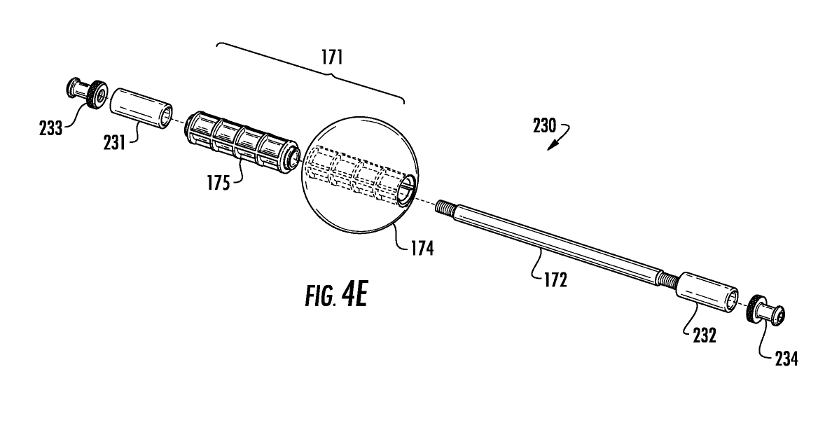

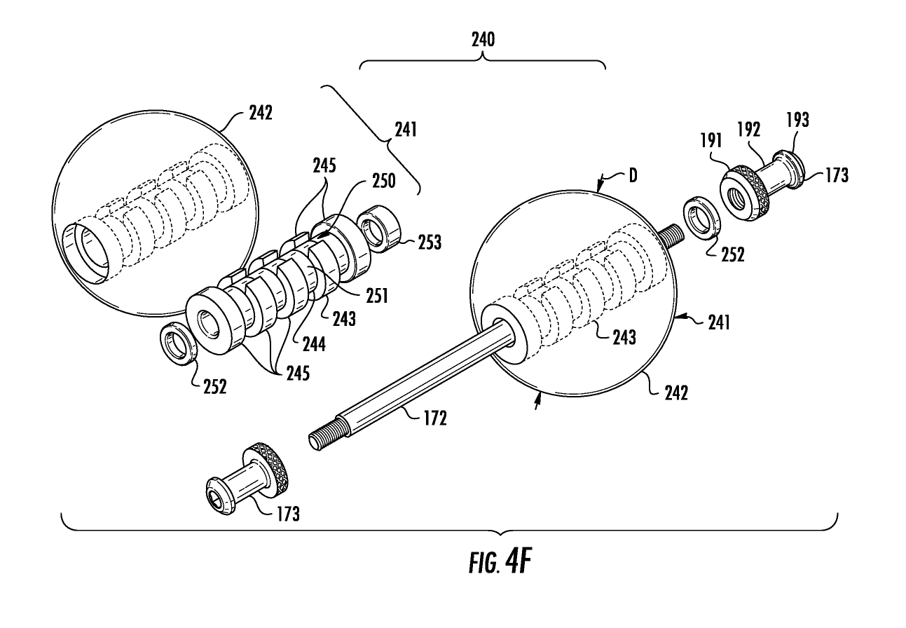

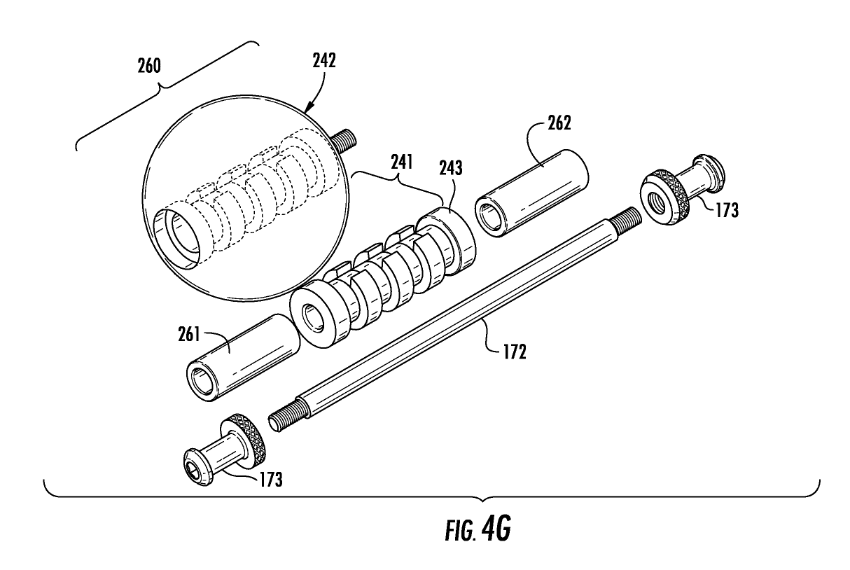

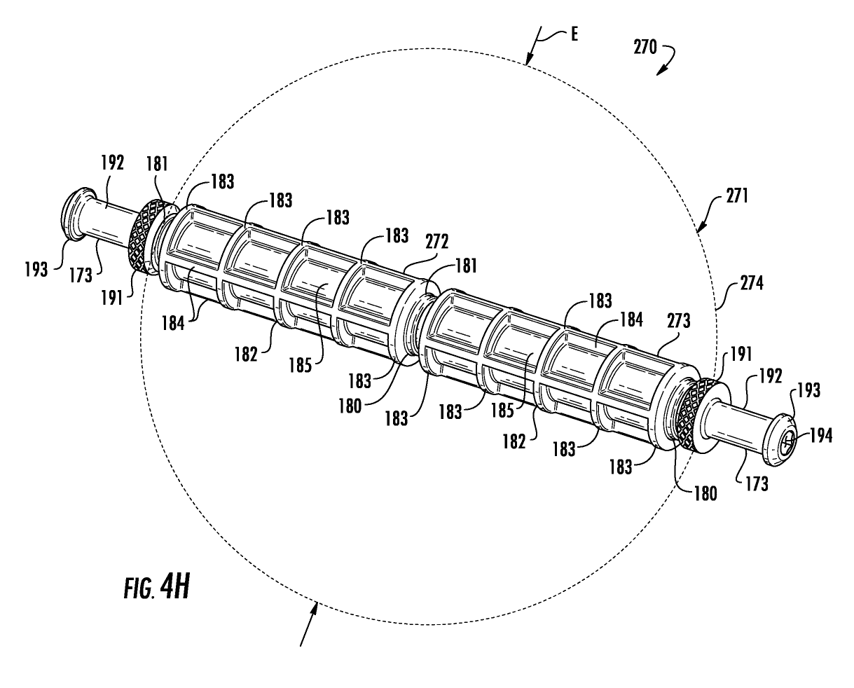

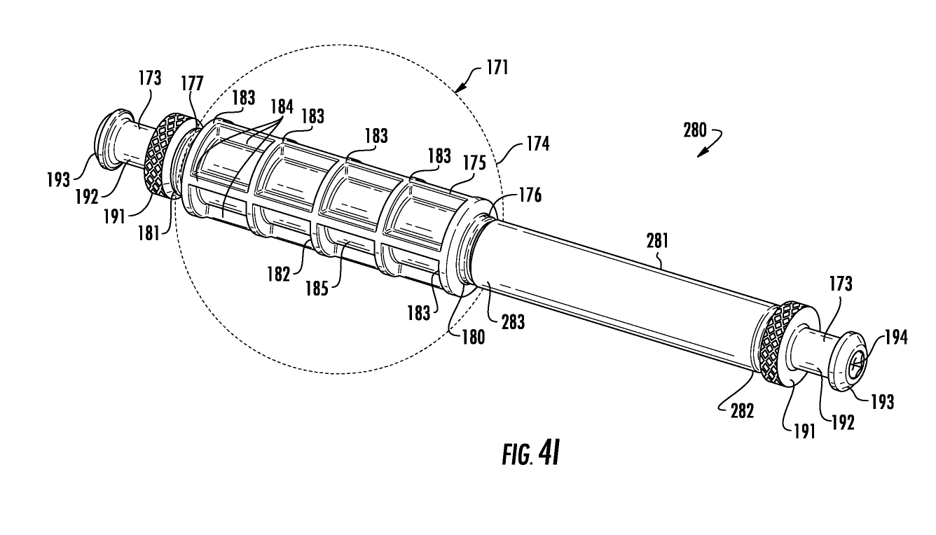

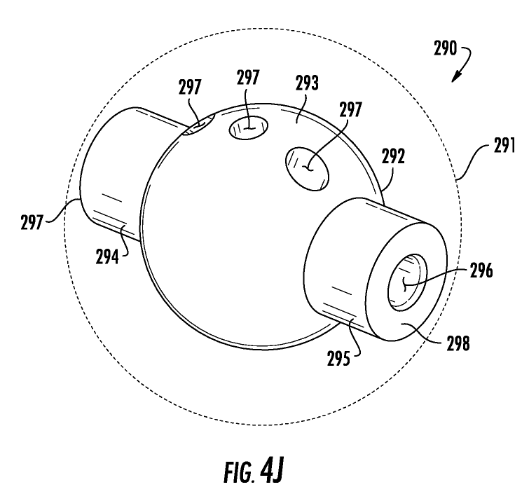

A first ball assembly 170 is shown in FIG. 4A and FIG. 4D. The first ball assembly 170 includes two identical ball units 171 mounted together, side-by-side on a single axle 172 between two nuts 173. Both the ball units 171 and the axle 172 are modular, such that they can be removed, replaced, and arranged in different fashions as will be described. Each ball unit 171 is a ball 174 carried on a hub 175. The ball 174 is formed integrally to the hub 175 in that it is preferably applied during manufacture and injection-molded over, heat-bonded, heat-shrunk, adhered, or otherwise bonded to the hub 175 such that the ball 174 cannot be removed from the hub 175 without causing substantial damage to the ball 174. The balls 174 are fairly compressible and yield under light loads. The balls 174 preferably have a Shore hardness value of between approximately 0026 and approximately 0052. The balls 174 are identical and have a diameter A as indicated in FIG. 4A.

While the balls 174 are compressible, the hubs 175 are very rigid. Both hubs 175 can be seen in FIG. 4A as the balls 174 are drawn in broken or hidden line, and in the exploded view of FIG. 4D, the hubs 175 are shown clearly. The hubs 175 are identical, and as such, only one hub 175 will be described. The hub 175 is generally long and cylindrical, having opposed first and second ends 176 and 177. The hub 175 has rotational symmetry about an axis, and is symmetric about a central plane bifurcating the hub 175; thus, the first and second ends 176 and 177 are opposite and identical. Axially-extending first and second flanges 180 and 181 project outward from a body 182 at the first and second ends 176 and 177, respectively. The flanges 180 and 181 have reduced diameters with respect to the diameter of the body 182 of the hub 175. The ball 174 is seated entirely over the body 182 of the hub 175, but the flanges 180 and 181 extend axially beyond the surface of the ball 174 a distance. The body 182 of the hub 175, contained and hidden within the ball 174, is formed with a plurality of corrugations or square depressions. Several continuous annular ribs 183 are spaced apart axially across the body 182, with a first annular rib 183 at the first end 176, a last annular rib 183 at the second end 177, and three annular ribs 183 spaced therebetween. One having ordinary skill in the art will appreciate that there may be slightly more or fewer annular ribs 183 in other embodiments. Intersecting those annular ribs 183, a plurality of axial ribs 184 are spaced apart annularly from each other. The axial ribs 184 extend axially entirely from the first annular rib 183 at the first end 176 to the last annular rib 183 at the second end 177. Both of the annular and axial ribs 183 and 184 project radially above a hub surface 185. The ball 174, again, is seated on the hub 175, such that the body of the ball 174 is formed over the annular ribs 183, over the axial ribs 184, and over the hub surface 185. The square depressions formed into the body 182 by the axial and annular ribs 183 and 184 prevent relative rotational and axial movement of the ball 174 on the hub 175. The balls 174 are compressible and thus would otherwise be susceptible to being deformed or rotated off of the hub surface 185.

The hub 175 is mounted for free rotation on the axle 172, so that the ball unit 171 is mounted for free rotation with respect to the axle 172. The hub 175 has a central bore 190, seen only in FIG. 4D, that extends entirely through the hub 175 in an axial direction. The bore 190 is just larger than the axle 172, and rides in rotation on the axle 172 in a plain bearing arrangement. The ends of the axle 172 are threaded to receive the nuts 173. The nuts 173 allow the first ball assembly 170 to rotate within a cradle when applied to the framework 11.

Referring to FIG. 4A, the nuts 173 secure and hold the ball units 171 on the axle 172 to maintain the first ball assembly 170 as a single piece. The nuts 173 are identical, and the description will refer only to one nut 173. The nut 173 has an enlarged base 191, a shank 192, and a head 193 opposed from the base 191. The shank 192 has a reduced diameter with respect to both the base 191 and the head 193. The base 191 has a larger diameter than the head 193. The base 191 and head 193 act as delimiters, as will be described. The outer circumference of the base 191 is knurled, and the head 193 is formed with a socket 194, such as would accept an allen wrench. The nut 173 is threaded onto the threaded end of the axle 172, thereby securing the nut 173 on the axle 172. The knurled base 191 allows an individual to easily grab and quickly rotate and threadably engage the nut 173 onto the axle 172, and the socket 194 allows an individual to use a tool—such as an allen wrench—to threadably engage the nut 173 onto the axle 172, where dexterity may not otherwise permit adequate threading and tightening.

The nuts 173 are used to cap the axle 172 at opposed ends. The nuts 173 contain the ball units 171 on the axle 172 and prevent lateral or axial movement of the ball units 171 thereon. FIG. 4A clearly shows two ball units 171 mounted to the axle 172. The balls 174 of the ball units 171 are spaced apart from each other by the first and second flanges 180 and 181 in between the balls 174. The balls 174 are also spaced apart from the nuts 173 by the first and second flanges 180 and 181 at the first and second ends 176 and 177. The first and second flanges 180 and 181 are plain bearings, allowing rotational movement of the ball units 171 with respect to the nuts 173 and with respect to each other. Indeed, because the balls 174 yield and compress under force during a massage, they bulge axially. And the balls 174 have a tacky or slightly adhesive quality. However, because the balls 174 are spaced apart by the first and second flanges 180 and 181, the balls 174 are prevented from rubbing against each other and or binding.

When so assembled, the first ball assembly 170 is ready for application into and use with the apparatus 10. The shanks 192 of the nuts 173 releasably engage with the cradles 13 to secure the first ball assembly 170 as part of the apparatus 10. Returning to FIG. 1, the first ball assembly 170 is shown applied to the framework 11 between the left and right side members 14 and 15. The first ball assembly 170 thus spans the gap between the left and right side members 14 and 15, and the ball units 171 are thus disposed in the air, free, and able to be rotated without interference. The nut 173 at the first end 176 of the hub 175 is fit into the ninth cradle 119, and the nut 173 at the second end 177 of the hub 175 is fit into the third cradle 113. The third and ninth cradles 113 and 119 are shown in FIG. 1 closed, or in the closed position, such that the first ball assembly 170 cannot be removed from the apparatus 10.

The enlarged base 191 on the nut 173 at the first end 176 of the hub 175 is placed in contact with the inner face 83 of the right rail member 81. The shank 192 is fit into the catch 136 of the ninth guard 149, disposed in the slot 132 of the inner portion 130 of the ninth cradle 119. The catch 136 is sized and shaped to closely receive the shank 192 to prevent jiggling or other loose movements, but not rotation. The shank 192 extends further into the ninth cradle 119, terminating with the head 193 disposed in the enlarged head 131 of the ninth cradle 119. The enlarged head 131 of the ninth cradle 119 is sized and shaped to closely receive the head 193 of the nut 173 to prevent loose movements. This engagement prevents the first ball assembly 170 from moving laterally (axially), vertically, and horizontally. The base 191 abuts the inner face 83 of the right rail member 81 and is thus prevented from moving laterally (axially) outward out of the framework 11. The jaw 135 of the ninth guard 149 limits vertical movement of the shank 192, thereby preventing the first end 176 from rising up out of the ninth cradle 119. The ninth guard 149 and the framework 11 also limit vertical movement of the shank 192, preventing the first end 176 from moving downward. The close fits of the shank 192 in the ninth guard 149 and the head 131 in the ninth cradle 119 similarly prevent the first end 176 from moving horizontally in forward or rearward directions. Thus, the first end 176 of the hub 175 is securely restrained by cooperation of the ninth cradle 119 and the ninth guard 149, so that the first ball assembly 170 cannot move with respect to the framework 11 other than in free rotation.

Just as the nut 173 at the first end 176 of the hub 175 is secured by cooperation of the ninth cradle 119 and the ninth guard 149, so is the nut 173 at the second end 177 of the hub 175 secured by cooperation of the third cradle 113 and the third guard 143. Still referring to FIG. 1, the nut 173 at the second end 177 of the hub 175 is fit into the third cradle 113.

The enlarged base 191 on the nut 173 at the second end 177 of the hub 175 is placed in contact with the inner face 80 of the right rail member 80. The shank 192 is fit into the catch 136 of the third guard 143, disposed in the slot 132 of the inner portion 130 of the third cradle 113. The catch 136 is sized and shaped to closely receive the shank 192 to prevent jiggling or other loose movements, but not rotation. The shank 192 extends further into the third cradle 113, terminating with the head 193 disposed in the enlarged head 131 of the third cradle 113. The enlarged head 131 of the third cradle 113 is sized and shaped to closely receive the head 193 to prevent loose movements. This engagement prevents the first ball assembly 170 from moving laterally (axially), vertically, and horizontally. The base 191 abuts the inner face 80 of the right rail member 80 and is thus prevented from moving laterally (axially) outward out of the framework 11. The jaw 135 of the third guard 143 limits vertical movement of the shank 192, thereby preventing the second end 177 from rising up out of the third cradle 113. The third guard 143 and the framework 11 also limit vertical movement of the shank 192, preventing the second end 177 from moving downward. The close fits of the shank 192 in the third guard 143 and the head 131 in the third cradle 113 similarly prevent the second end 177 from moving horizontally in forward or rearward directions. Thus, the second end 177 of the hub 175 is securely restrained by cooperation of the third cradle 113 and the third guard 143, so that the first ball assembly 170 cannot move with respect to the framework 11 other than in free rotation.

Turning to FIG. 2A, the nuts 173 in the third and ninth guards 143 and 149 can be seen more clearly. Here, the third and ninth cradles 113 and 119 are closed. The trigger 22 is in the advanced position, the chassis rail 12 is in the closed position, and the first ball assembly 170 is seated and secured in the framework 11. When the individual desires to remove the first ball assembly 170, he pulls or draws back on the trigger 22 to move the trigger 22 into the retracted position, thereby moving the chassis rail 13 into the retracted position. When the chassis rail 13 is in the retracted position, each of the cradles 13 are moved into the open position, as shown in FIG. 2B. The jaws 135 of the third and ninth guards 143 and 149 are drawn back into the framework 11 and out of the slots 132, thereby opening the third and ninth cradles 113 and 119. The first ball assembly 170 can now be removed vertically from the apparatus 10 simply by grasping the first ball assembly 170 and pulling upward along line B. In this way, the first ball assembly 170 is removed, and the apparatus 10 is left with a void extending between the third and ninth cradles. The individual now has the option to leave this void empty, such as may be necessary for a different massage arrangement, or insert a new ball assembly for another different massage arrangement.

Referring now to FIG. 4B, a second ball assembly 200 is shown. The second ball assembly 200 is very similar in appearance to the first ball assembly 170 but includes a unique characteristic different from the first ball assembly 170. In the second ball assembly, the balls are offset within the ball units, providing the individual with the ability to rearrange the ball units to position the balls differently.

The second ball assembly 200 includes two identical ball units 201 mounted together, side-by-side on a single axle between two nuts 203. Both the ball units 201 and the axle are modular, such that they can be removed, replaced, and arranged in different fashions as will be described. The ball unit 201 is a ball 204 carried on a hub 205. The ball 204 is formed integrally to the hub 205 in that it is preferably applied during manufacture and injection-molded over, heat-bonded, heat-shrunk, adhered, or otherwise bonded to the hub 205 such that the ball 204 cannot be removed from the hub 205 without causing substantial damage to the ball 204. The balls 204 are fairly compressible and yield under light loads. The balls 204 are opposite and identical and have a diameter C as indicated in FIG. 4B. Diameter C is equal to the diameter A of the balls 174 in the first ball assembly 170.

While the balls 204 are compressible, the hubs 205 are very rigid. Both hubs 205 can be seen in FIG. 4B since the balls 204 are drawn in broken line. The hubs 205 are identical, and as such, only one hub 205 will be described. The hub 205 is generally long and cylindrical, having opposed first and second ends 206 and 207. The hub 205 has rotational symmetry about an axis. Axially-extending first and second flanges 210 and 211 project outward from a body 212 at the first and second ends 206 and 207, respectively. The flanges 210 and 211 have reduced diameters with respect to the diameter of the body 212 of the hub 205. The flanges are different in axial length: the flange 210 is larger than the flange 211. The flange 210 is preferably twice as long in an axial direction as the flange 211. In other embodiments, that ratio is larger. The ball 204 is seated entirely over the body 212 of the hub 205, but the flanges 210 and 211 extend axially beyond the surface of the ball 204 a distance. The body 212 of the hub 205, contained and hidden within the ball 204, is formed with a plurality of corrugations or square depressions. Several continuous annular ribs 213 are spaced apart axially across the body 212, with a first annular rib 213 at the first end 206, a last annular rib 213 at the second end 207, and three annular ribs 213 spaced therebetween. One having ordinary skill in the art will appreciate that there may be slightly more or fewer annular ribs 213 in other embodiments. Intersecting those annular ribs 213, a plurality of axial ribs 214 are spaced apart annularly from each other. The axial ribs 214 extend axially entirely from the first annular rib 213 at the first end 206 to the last annular rib 213 at the second end 207. Both of the annular and axial ribs 213 and 214 project radially above a hub surface 215. The ball 204, again, is seated on the hub 205, such that the body of the ball 204 is formed over the annular ribs 213, over the axial ribs 214, and over the hub surface 215.

The hub 205 is mounted for free rotation on the axle 202, so that the ball unit 201 is mounted for free rotation with respect to the axle 202. The hub 205 has a central bore, not seen in FIG. 4B but similar to the bore 190 of the hub 185 shown in FIG. 4B, that extends entirely through the hub 205 in an axial direction. The bore is just larger than the axle 202, and rides in rotation on the axle 202 in a plain bearing arrangement. The ends of the axle 202 are threaded to receive the nuts 203.

Referring still to FIG. 4B, the nuts 203 secure and hold the ball units 201 on the axle 202 to maintain the ball assembly 200 as a single piece. The nuts 203 are identical, and the description will refer only to one nut 203. Further, the nuts 203 are virtually identical to the nuts 173, but are referenced here separately for clarity; in this embodiment, the nuts 203 may be of a slightly different size to the nuts 203, though otherwise are identical. The nut 203 has an enlarged base 221, a shank 222, and a head 223 opposed from the base 221. The shank 222 has a reduced diameter with respect to both the base 221 and the head 223. The base 221 has a larger diameter than the head 223. The base 221 and head 223 act as delimiters, as will be described. The outer circumference of the base 221 is knurled, and the head 223 is formed with a socket 224, such as would accept an allen wrench. The nut 203 is threaded onto the threaded end of the axle 202, thereby securing the nut 203 on the axle 202. The knurled base 221 allows an individual to easily grab and quickly rotate and threadably engage the nut 203 onto the axle 202, and the socket 224 allows an individual to use a tool—such as an allen wrench—to threadably engage the nut 203 onto the axle 202, where dexterity may not otherwise permit adequate threading and tightening.

The nuts 203 are used to cap the axle 202 at opposed ends. The nuts 203 contain the ball units 201 on the axle 202 and prevent lateral or axial movement of the ball units 201 thereon. FIG. 4B clearly shows two ball units 201 mounted to the axle 202. The balls 204 of the ball units 201 are spaced apart from each other by the first and second flanges 210 and 211 in between the balls 204. The balls 204 are also spaced apart from the nuts 203 by the first and second flanges 210 and 211 at the first and second ends 206 and 207. The first and second flanges 210 and 211 are plain bearings, allowing rotational movement of the ball units 201 with respect to the nuts 203 and with respect to each other. Indeed, because the balls 204 yield and compress under force during a massage, they bulge axially. And the balls 204 have a tacky or slightly adhesive quality. However, because the balls 204 are spaced apart by the first and second flanges 210 and 211, the balls 204 are prevented from rubbing against each other and or binding.

As can be seen in FIG. 4B, the second ends 207 of the hubs 205 of the ball units 201 oppose and are against each other. Because the flanges 211 at the second ends 207 are twice as long axially as the flanges 210 at the first ends 205, the balls 204 of the ball units 201 are spaced apart by a comparatively large gap. However, should the individual decide that a smaller gap be needed or desired for a specific massage technique, he merely needs to remove one of the caps 203 by threadably dis-engaging it from the axle 202, sliding the ball units 201 off the axle 202, and flipping one or both of the ball units 201. If one ball unit 201 is flipped in orientation, such that the first end 206 of one ball unit 201 is against the second end 207 of another ball unit 201, the gap is reduced to three-fourths of its original size. If both ball units 201 are flipped in orientation, such that the first ends 206 are against each other, then the gap is reduced to one-half of its original size. In this way, the individual can create one of several unique massage arrangements with the same two ball units 201.

When so assembled in one of these arrangements, the second ball assembly 200 is ready for application into and use with the apparatus 10. The shanks 222 of the nuts 203 releasably engage with the cradles 13 to secure the second ball assembly 200 as part of the apparatus 10. Returning to FIG. 1, the second ball assembly 200 of the embodiment shown in FIG. 4B is applied to the framework 11 between the left and right side members 14 and 15. The second ball assembly 200 spans the gap between the left and right side members 14 and 15, and the ball units 201 are thus disposed in the air, free, and able to be rotated without interference. The nut 203 at the first end 206 of the hub 205 is fit into the tenth cradle 120, and the nut 203 at the first end 206 of the hub 205 is fit into the fourth cradle 124, so that the balls 105 are spaced apart by a large gap and offset toward the left and right side members 14 and 15, respectively. The fourth and tenth cradles 113 and 119 are shown in FIG. 1 closed, or in the closed position, such that the second ball assembly 200 cannot be removed from the apparatus 10.

The enlarged base 221 on the nut 203 at the first end 206 of the hub 205 is placed in contact with the inner face 83 of the right rail member 81. The shank 222 is fit into the catch 136 of the tenth guard 150, disposed in the slot 132 of the inner portion 130 of the tenth cradle 120. The catch 136 is sized and shaped to closely receive the shank 222 to prevent jiggling or other loose movements. The shank 222 extends further into the tenth cradle 120, terminating with the head 223 disposed in the enlarged head 131 of the tenth cradle 120. The enlarged head 131 of the tenth cradle 120 is sized and shaped to closely receive the head 223 to prevent loose movements. This engagement prevents the second ball assembly 200 from moving laterally (axially), vertically, and horizontally. The base 221 abuts the inner face 83 of the right rail member 81 and is thus prevented from moving laterally (axially) outward out of the framework 11. The jaw 135 of the tenth guard 150 limits vertical movement of the shank 222, thereby preventing the first end 206 from rising up out of the tenth cradle 120. The tenth guard 150 and the framework 11 also limit vertical movement of the shank 222, preventing the first end 206 from moving downward. The close fits of the shank 222 in the tenth guard 150 and the head 131 in the tenth cradle 120 similarly prevent the first end 206 from moving horizontally in forward or rearward directions. Thus, the first end 206 of the hub 205 is securely restrained by cooperation of the tenth cradle 120 and the tenth guard 150.

Just as the nut 203 at the first end 206 of the hub 205 for the “right” ball unit 201 is secured by cooperation of the tenth cradle 120 and the tenth guard 150, so is the nut 203 at the first end 206 of the hub 205 of the “left” ball unit 201 secured by cooperation of the fourth cradle 113 and the fourth guard 143. Still referring to FIG. 1, the nut 203 at the first end 206 of the hub 205 is fit into the fourth cradle 113.

The enlarged base 221 on the nut 203 at the first end 206 of the hub 205 is placed in contact with the inner face 80 of the right rail member 80. The shank 222 is fit into the catch 136 of the fourth guard 143, disposed in the slot 132 of the inner portion 130 of the fourth cradle 113. The catch 136 is sized and shaped to closely receive the shank 222 to prevent jiggling or other loose movements, but not free rotation of the second ball assembly 200. The shank 222 extends further into the fourth cradle 113, terminating with the head 223 disposed in the enlarged head 131 of the fourth cradle 113. The enlarged head 131 of the fourth cradle 113 is sized and shaped to closely receive the head 223 to prevent loose movements. This engagement prevents the second ball assembly 200 from moving laterally (axially), vertically, and horizontally. The base 221 abuts the inner face 80 of the right rail member 80 and is thus prevented from moving laterally (axially) outward out of the framework 11. The jaw 135 of the fourth guard 143 limits vertical movement of the shank 222, thereby preventing the first end 206 from rising up out of the fourth cradle 113. The fourth guard 143 and the framework 11 also limit vertical movement of the shank 222, preventing the first end 206 from moving downward. The close fits of the shank 222 in the fourth guard 143 and the head 131 in the fourth cradle 113 similarly prevent the first end 206 from moving horizontally in forward or rearward directions. Thus, the first end 206 of the hub 205 is securely restrained by cooperation of the fourth cradle 113 and the fourth guard 143, so that the second ball assembly 200 cannot move with respect to the framework 11 other than in free rotation.

Turning to FIGS. 1 and 2A, the nuts 203 in the fourth and tenth cradles 114 and 120 can be seen more clearly. Here, the fourth and tenth cradles 114 and 120 are closed. The trigger 22 is in the advanced position, the chassis rail 12 is in the closed position, and the second ball assembly 200 is seated and secured in the framework 11. When the individual desires to remove the second ball assembly 200, he pulls or draws back on the trigger 22 to move the trigger 22 into the retracted position, thereby moving the chassis rail 13 into the retracted position. When the chassis rail 13 is in the retracted position, each of the cradles 13 are moved into the open position, as shown in FIG. 2B. The jaws 135 of the fourth and tenth guards 144 and 150 are drawn back into the framework 11 and out of the slots 132, thereby opening the fourth and tenth cradles 114 and 120. The second ball assembly 200 can now be removed vertically from the apparatus 10 simply by grasping the second ball assembly 200 and pulling upward along the same line B as for the first ball assembly 170. In this way, the second ball assembly 200 is removed, and the apparatus 10 is left with a void extending between the fourth and tenth cradles 114 and 120. The individual now has the option to leave this void empty, such as may be necessary for a different massage arrangement, or insert a new ball assembly for another different massage arrangement.

Referring now to FIGS. 4C and 4E, a third ball assembly 230 is shown. The third ball assembly 230 uniquely includes only a single central ball. However, the third ball assembly 230 is formed by some of the same structural elements and features as the first and second ball assemblies 170 and 200. As such, those same structural elements and features will be identified with the reference characters used with respect to the first and second ball assemblies 170 and 200, to emphasize that the parts are the same. Therefore, much of the description of those same structural elements and features need not be repeated here. Despite some of the similar parts, the third ball assembly 230 employs some different parts, thus providing the individual with yet another arrangement for a unique massage.

The third ball assembly 230 includes the single ball unit 171 mounted between left and right spacers 231 and 232 on the single axle 172 (shown in FIG. 4E only). The ball unit 171 includes the ball 174 carried on the hub 175.

The left and right spacers 231 and 232 flank the sides of the ball unit 171 in the third ball assembly 230. The left and right spacers 231 and 232 are each long and cylindrical, having ends which are opposed and identical. The left and right spacers 231 and 232 each have rotational symmetry about an axis and are symmetric about a central bifurcating plane. The left and right spacers 231 and 232 have lengths roughly two-thirds the diameter A of the ball 174.

The left and right spacers 231 and 232 are in plain bearing contact with the first and second flanges 180 and 181 of the hub 175. The left spacer 231 is in contact with the second flange 181, and the right spacer 232 is in contact with the first flange 180. The first and second flanges 180 and 181 are identical and equal in size, so that the ball unit 171 is symmetric about a central plane perpendicular to its axis.

Left and right nuts 233 and 234 secure and hold the ball unit 171 and the left and right spacers 231 and 232 on the axle 172. The left and right nuts 233 and 234 are identical to each other and to the nuts 173, but are given their own reference character here so as to more easily differentiate the orientation of the third ball assembly 230 when applied in the apparatus 10. It should be clearly understood, however, that the left and right nuts 233 and 234 are identical to the nuts 173. As such, the left and right nuts 233 and 234 each have a base 191, a shank 192, a head 193, and a socket 194. The nuts 233 and 234 are threaded onto the axle 172 at opposed thereof to prevent lateral or axial movement of the ball unit 171 and the left and right spacers 231 and 232 thereon. As a result, during use, the ball 174 maintains its central position in the third ball assembly 230.

When so assembled, the third ball assembly 230 is ready for application into and use with the apparatus 10. Exactly as the nuts 173 engage with the cradles 13, so do the left and right nuts 233 and 234 engage with the cradles 13. FIG. 1 shows two instances of the third ball assembly 230 engaged at opposed ends of the apparatus 10. One of the third ball assemblies 230 is shown applied to the framework 11 between the left and right side members 14 and 15 spanning the gap therebetween, and thus disposing its ball unit 171 in the air, free, and able to be rotated without interference. The left nut 255 is fit into the first cradle 111, and the right nut 256 is fit into the seventh cradle 117. The other of the third ball assemblies 230 is also shown applied to the framework 11 between the left and right side members 14 and 15 spanning the gap therebetween, and thus disposing its ball unit 171 in the air, free, and able to be rotated without interference. That third ball assembly 230 extends between the fifth cradle 115 and eleventh twelfth cradle 121. Each of these cradles is closed in FIG. 1.

Application of the first and second ball assemblies 170 and 200 to the apparatus 10, and removal therefrom, has been described at length above. The third ball assembly 230 is applied, secured, removed in a similar manner, and as such, need not be explained again. One having ordinary skill in the art will readily appreciate that the same process is used, substituting the first and seventh cradles 111 and 117 for those in the description of the first and second ball assemblies 170 and 200. It is, of course, worth noting that, just as with the first and second ball assemblies 170 and 200, the third ball assembly 230 can be placed in any set of opposing cradles 13 across the apparatus 10.

Turning now to FIG. 4F, a fourth ball assembly 240 is shown. FIG. 4F illustrates a partially exploded view of the fourth ball assembly 240 with one ball unit on the axle 172 and one ball unit off the axle in an exploded state. The fourth ball assembly 240 exploits a two-ball arrangement with a different hub that in the ball units 171. The fourth ball assembly 240 includes two identical ball units 241 mounted together on the single axle 172 between spacers and two nuts 173. The ball unit 241 is a ball 242 carried on a hub 243. The ball 242 is formed integrally to the hub 243 in that it is preferably applied during manufacture and injection-molded over, heat-bonded, heat-shrunk, adhered, or otherwise bonded to the hub 243 such that the ball 242 cannot be removed from the hub 243 without causing substantial damage to the ball 242. The balls 242 are fairly compressible and yield under light loads. The balls 242 are identical and have a diameter D just less than the diameter A of the balls 174.

While the balls 242 are compressible, the hubs 243 are very rigid. The hubs 243 are identical, and as such, only one hub 243 will be described. The hub 243 is generally long and cylindrical, having ends which are opposite and identical. The hub 243 has rotational symmetry about an axis, and is symmetric about a central plane bifurcating the hub 243. The ends are flush with the outer surface of the ball 242 such that no flange or portion of the hub 243 extends beyond the ball 242. The ball 242 is seated entirely over a body 244 of the hub 243. The body 244 of the hub 243, contained and hidden within the ball 242, is formed with a plurality of spaced-part annular ribs 245 are spaced apart axially across the body 244, with a first annular rib 245 at the one end, a last annular rib 245 at the opposed end, and three annular ribs 245 spaced therebetween. One having ordinary skill in the art will appreciate that there may be slightly more or fewer annular ribs 245 in other embodiments. The first and last annular ribs 245 are continuous. The inner three annular ribs 245, however, are severed. A longitudinal, or axial, groove or channel 250 extends entirely through each of the annular ribs 245, forming a wedge-shaped void in each of the annular ribs 245 common in radial orientation among the annular ribs 245. The channel 250 extends from the outer face of the ribs 245 to a hub surface 251. The ball 242, again, is seated on the hub 243, such that the body of the ball 242 is formed over the annular ribs 245 and over the hub surface 251. The axial channel 250 ensures that the ball 242 stays secured on the hub 243; it prevents relative rotational movement of the ball 242 and the hub 243.

The hub 243 is mounted for free rotation on the axle 172, so that the ball unit 241 is mounted for free rotation with respect to the axle 172. Two types of spacers are also mounted on the axle 172 for free rotation. Two washers 252 are carried on the axle 172, and a single short spacer 253 is as well. In the embodiment shown in FIG. 4F, the washers 252 are located between each ball unit 241 and its proximate nut 173 and provide a plain bearing surface therebetween. The short spacer 253 is located between the two ball units 241 and provides a plan bearing surface therebetween. The short spacer 253 is sufficiently wide to prevent the balls 242 from rubbing against each other and binding.

The nuts 173 secure and hold the two washers 252, the two ball units 241, and the short spacer 253 on the axle 172 to maintain the fourth ball assembly 240 as a single piece. The nuts 173 are identical to those used with the other ball assemblies. They prevent lateral or axial movement of the components on the axle 172.

FIG. 1 does not illustrate the fourth ball assembly 240 applied to the apparatus 10. However, application to and removal from the apparatus 10 is the same for the fourth ball assembly 240 as it is for the first, second, and third ball assemblies 170, 200, and 230, and as such, no further explanation is necessary. Because the fourth assembly 240 is built on the same axle 172 and capped with the same nuts 173, it should be understood that the fourth ball assembly 240 can be placed in any of the sets of opposing cradles 13 across the apparatus 10, just as the first, second, and third assemblies 170, 200, and 230 can be.

Turning now to FIG. 4G, a fifth ball assembly 260 is shown. FIG. 4G shows the fifth ball assembly 260 in an exploded view. The fifth ball assembly 260 is similar to the fourth ball assembly 240 but has only a single central ball rather than two balls on the axle 172. Indeed, the fifth ball assembly 260 includes the same ball unit 241 used in the fourth ball assembly 240, and thus includes the same ball 242 and hub 243. The hub 243 has the body 244, the annular ribs 245, and the channel 250. The ball unit 241 is mounted on the axle 172.

Identical left and right spacers 261 and 262 flank the hub 243 on either side. The left and right spacers 261 and 262 are very similar to the left and right spacers 231 and 232 of the third ball assembly 230. The left and right spacers 261 and 262 are long and cylindrical, and are disposed between the hub 243 of the ball unit 241 and each of the nuts 271. The left and right spacers 261 and 262 each have rotational symmetry about an axis and are symmetric about a central bifurcating plane. The left and right spacers 261 and 262 have lengths roughly two-thirds the diameter D of the ball 242. The left and right spacers 261 and 262 are in plain bearing contact with the hub 243.

FIG. 1 does not illustrate the fifth ball assembly 260 applied to the apparatus 10. However, FIG. 1 does show the similar third ball assembly 230, which also has only a single central ball, applied to the apparatus 10. Application to and removal from the apparatus 10 is the same for the fifth ball assembly 260 as it is for this third ball assembly 230, and indeed is the same as for the first, second, and fourth ball assemblies 170, 200, and 240. Because the fifth ball assembly 260 is built on the same axle 172 and capped with the same nuts 173, it should be understood that the fifth ball assembly 260 can be placed in any of the sets of opposing cradles 13 across the apparatus, just as the other ball assemblies 170, 200, 230, and 240 can be.

FIG. 4H illustrates a sixth ball assembly 270. The sixth ball assembly 270 is unique because it provides one large ball having a diameter that occupies nearly the entire axle. The sixth ball assembly 270 includes one ball unit 271 including two adjacent hubs 272 and 273 and a ball 274 mounted over both of the hubs 272 and 273. The ball 274 is formed integrally to the hubs 272 and 273 in that it is preferably applied during manufacture and is injection-molded over, heat-bonded, heat-shrunk, adhered, or otherwise bonded to the hubs 272 and 273 such that the ball 274 cannot be removed from the hubs 272 and 273 without causing substantial damage to the ball 274. The ball 274 has a large diameter E as indicated in FIG. 4H.

The ball 274, like the other balls in the other ball assemblies, is preferably fairly compressible. However, the sixth ball assembly 270 is unique in that a large, hard single ball can provide effective trigger point massage therapy. The hubs 272 and 273 are rigid. The hubs 272 and 273 identical to each other and to the hub 175 of the first ball assembly 170. Thus, only the hub 272 is described here, and it is described with the same structural features and elements, and the same reference characters corresponding to those features and elements, as the hub 175. Therefore, the hub 272 includes axially-extending first and second flanges 180 and 181 at opposed first and second ends, respectively, of the hub 272. However, because the hubs are nested within the ball 274, only the first end 180 of the hub 273 extends beyond the surface of the ball 274, and only the second end 181 of the opposed hub 272 extends beyond the surface of the ball 274.

The body 182 of the hub 272 is formed with a plurality of corrugations or square depressions created by the intersection of the several annular ribs 183 with the several axial ribs 184 projecting above the hub surface 185. The square depressions formed into the body by the axial and annular ribs 183 and 184 prevent relative rotational and axial movement of the ball 274 on the hub 175.

The hubs 272 and 273 are mounted for free rotation on the axle 172 (not shown in FIG. 4H but identically located as in the other ball assemblies), so that the hubs 272 and 273 are mounted for free rotation with respect to the axle 172. The hubs 272 and 273 rotate together so that the ball 274 rotates about the axle 172 evenly across its diameter without torsion. The ball unit 271 is prevented from lateral movement on the axle 172 by the nuts 173, each of which has the knurled base 191, shank 192, head 193, and socket 194. The first and second flanges 180 and 181 on the hubs 273 and 272, respectively, are plain bearings against the nuts 173, allowing rotational movement of the ball unit 271 with respect to the nuts 173.

FIG. 1 does not illustrate the sixth ball assembly 270 applied to the apparatus 10. However, FIG. 1 does show the similar third ball assembly 230, which has only a single, yet small, central ball, applied to the apparatus 10. Application to and removal from the apparatus 10 is the same for the sixth ball assembly 270 as it is for this third ball assembly 230, and indeed is the same as for the first, second, fourth, and fifth ball assemblies 170, 200, 240, and 260. Because the sixth ball assembly 270 is built on the same axle 172 and capped with the same nuts 173, it should be understood that the sixth ball assembly 270 can be placed in any of the sets of opposing cradles 13 across the apparatus, just as the other ball assemblies 170, 200, 230, 240, and 260 can be. Moreover, it is especially noted that the diameter of the ball 274 is sufficiently large that it occupies generally the entire gap between the left and right side members 14 and 15 when applied to nay of the sets of cradles 13. Nevertheless, the ball 274 is still disposed in the air, free, and able to be rotated without interference, because of the height of the major and minor feet 34, 35, 41, and 42.

Referring now to FIG. 4I, a seventh ball assembly 280 is shown. The seventh ball assembly 280 uniquely has a ball offset from center along the axle 172. The seventh ball assembly 280 is formed by most of the same structural elements and features as the first ball assembly 170. The seventh ball assembly 280 includes the single ball unit 171 mounted adjacent to a large spacer 281. The single ball unit 171 includes the ball 174 mounted on the hub 175. The hub 175 has the opposed first and second flanges 180 and 181 at the opposed first and second ends 176 and 177, respectively.

The spacer 281 has opposed ends 282 and 283. The spacer 281 is long and cylindrical, and the opposed ends 282 and 283 are symmetric. The spacer 281 has rotational symmetry about an axis and is symmetric about a central bifurcating plane. The spacer 281 has a length approximately equal to the diameter A of the ball 174. The end 283 is in plan bearing contact with the first end 180 of the ball unit 171. Because both the ball unit 171 and the spacer 281 are symmetric, however, they are modular, and the end 282 can be placed against the first or second ends 180 and 181 of the ball unit 171, or the end 283 can be placed against the second end 181 of the hub 181, depending on how the individual arranges the seventh ball assembly 280. The spacer 281 and hub 175 are plain bearings against the nuts 173, which cap the axle 172 and prevent lateral movement of the spacer 281 and hub 175 on the axle 172.

FIG. 1 does not illustrate the seventh ball assembly 280 applied to the apparatus 10. Application to and removal from the apparatus 10 is the same for the seventh ball assembly 280 as it is for all other ball assemblies. Because the seventh ball assembly 280 is built on the same axle 172 and capped with the same nuts 173, it should be understood that the seventh ball assembly 280 can be placed in any of the sets of opposing cradles 13 across the apparatus, just as the other ball assemblies can be. Moreover, it is noted that the seventh ball assembly provides the unique arrangement of an offset ball to provide a different massage arrangement. Further, the seventh ball assembly 280 can be rearranged to place the ball 174 on the other side of the axle 172, or the entire seventh ball assembly 280 can simply be flipped in orientation on the apparatus 10 to place the ball 174 proximate the left or side member 14 and 15, as the individual may desire.

Turning now to FIG. 4J, a ball unit 290 is shown. The ball unit 290 is suitable for use in any of the first, second, third, fourth, fifth, sixth or seventh ball assemblies 170, 200, 230, 240, 260, 270, and 280, just as any of the balls of those ball assemblies are modular and may be swapped into and out of the other ball assemblies. The ball unit 290 includes a ball 291 carried on a hub 292. The ball 291 is formed integrally to the hub 292 and is applied during manufacture, such as by injection-molding, heat bonding, heat shrinking, adhering, or otherwise bonding to the hub 292 such that the ball 291 cannot be removed from the hub 292 without causing substantial damage to the ball 292. The ball 291 is fairly compressible and yields under light loads.

The hub 292, in contrast, is rigid. It is uniquely formed, including a central orb 293 and two projecting lobes 294 and 295. The orb 293 and lobes 294 and 295 are formed integrally to each other, monolithically, as a single piece. A bore 296 extends coaxially and entirely through the orb 293 and the lobes 294 and 295. The orb 293 is a globe having rotational symmetry. On opposed sides of the orb 293, the lobes 294 and 295 extend radially outward oppositely from each other. Three holes 297 are formed into the orb 293, defining a plane together with the lobes 294 and 295. The three holes 297 improve cure rates and manufacture times of the ball unit 290, and prevents the relative rotational movement of the ball 291 with respect to the hub 292. The lobes 294 and 295 are each cylindrical projections from the orb 292 terminating in ends 297 and 298, respectively. The ends 297 and 298 are formed coextensively to the surface of the ball 291; each is disposed flush with the surface of the ball 291, but is flat.

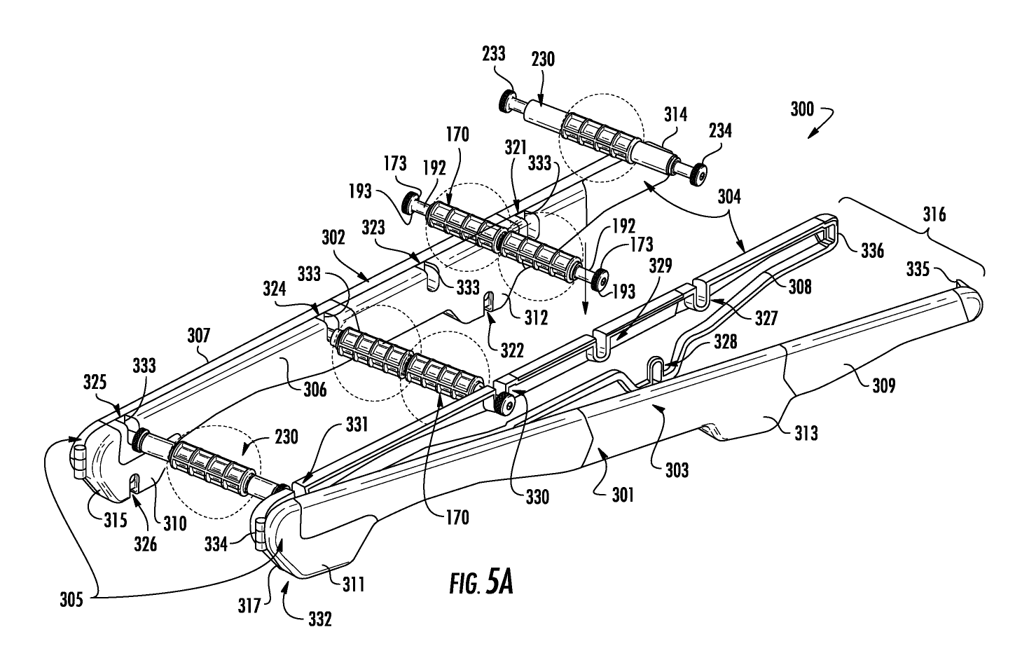

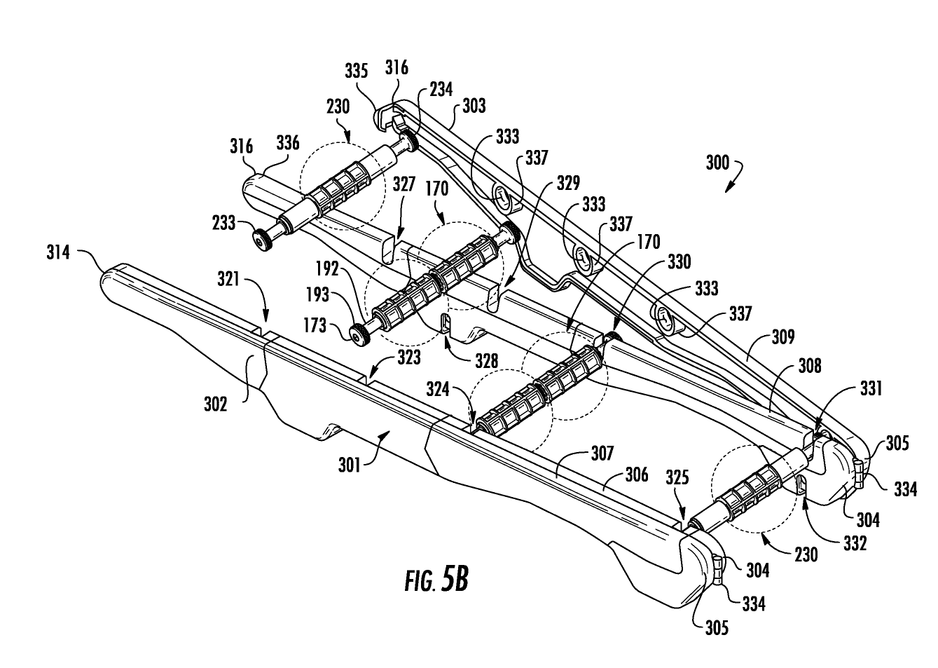

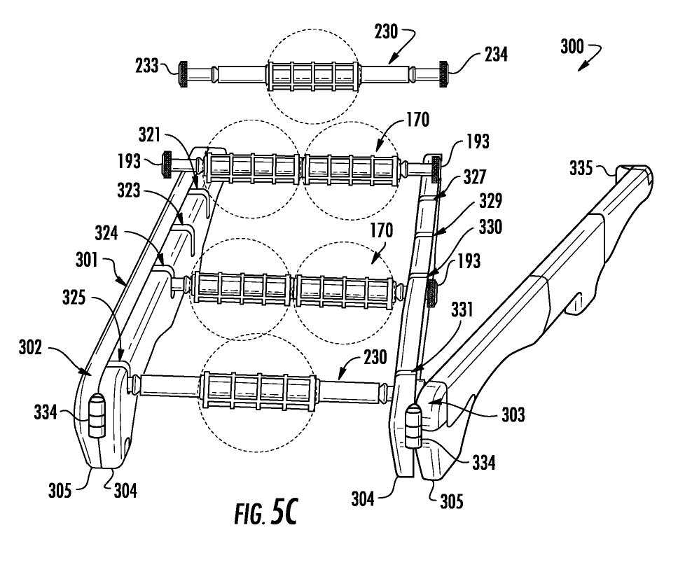

FIGS. 5A-5C illustrate an alternate embodiment of a modular self-massage apparatus 300. The apparatus 300 includes an external framework 301 including opposed left and right side members 302 and 303, cooperating to define an inner portion 304 and an outer portion 305. Both of the left and right side members 302 and 303 are bifurcated vertically: the left side member 302 is split into an inner half 306 and an opposed outer half 307, and the right side member 303 is split into an inner half 308 and an opposed outer half 309. It should be noted that although the term “half” is used to describe parts of the left and right side members 302 and 303, those parts are not true halves of a whole; they are not equal in size. The inner halves 306 and 308 define the inner portion 304 of the framework 301, and the outer halves 307 and 309 define the outer portion 305 of the framework 301. The inner and outer portions 304 and 305 are pivoted to move in a swinging fashion to move between open and closed positions. As can be seen, the left and right side members 302 and 303 are very similar to the left and right side members 14 and 15 in the apparatus 10, though not coupled to each other by braces. As such, some structural elements and features are not described in detail, as one having ordinary skill in the art will readily appreciate that the structures in the apparatus 10 and 300 are the same.

The left side member 301 is elongate and relatively thin and short. The right side member 302 is similarly elongate and relatively thin and short. Indeed, the left and right side members 301 and 302 are identical but opposite in orientation on the framework, mirrored about a centerline extending therebetween. The left and right side members 301 and 302 are spaced apart from each other, are parallel with respect to each other, and, in this parallel fashion, are disposed in the same plane such that their tops are coplanar. The left and right side members 301 and 302 are available to be gripped by hand nearly anywhere along their entire lengths, so as to provide varied and unique hand angles to exert similarly varied and unique forces.

The left and right side members 302 and 303 are spaced apart only by the ball assemblies, shown here in FIG. 5A as the first and third ball assemblies 170 and 230. The framework 301 is constructed from a material or combination of materials having the material characteristics of low density, high rigidity, high tensile strength, high compressive strength, and durability, such as plastic. When the ball assemblies are applied to the framework 301, the apparatus 300 becomes rigid.

Each of the left and right side members 302 and 303 include top surfaces, similar to the top surface 30 of the apparatus 10. The top surfaces of the left and right side members are bifurcated by the inner and outer portions 304 and 305. Additionally, each of the left and right side members 302 and 303 include bottom surfaces, which, similar to the bottom surface 40 of the apparatus 10, includes major feet 310 and 311 and minor feet 312 and 313.

The left side member 302 includes opposed first and second ends 314 and 315, and the right side member 303 includes opposed first and second ends 316 and 317. The first ends 314 and 316 are similar to the first ends 31 and 51 of the apparatus 10, respectively, and the second ends 315 and 317 are similar to the second ends 32 and 53 of the apparatus 10, respectively.

Unlike the apparatus 10, however, the apparatus 300 includes no trigger 22 and no chassis rail 12 to lock the ball assemblies in place. Instead, the inner and outer portions 304 and 305 are pivoted to each other to move between an open position, in which cradles are opened, and a closed position, in which cradles are closed.

The cradles are capture means for holding and securing the ball assemblies. The left side member 302 includes first, second, third, fourth, fifth, and sixth cradles 321, 322, 323, 324, 325, and 326, each of which is located in a location corresponding to the first, second, third, fourth, fifth, and sixth cradles 111-116 in the apparatus 10, respectively. The cradles 321-326 are formed into the inner half 306 of the left side member 302. The right side member 303 includes seventh, eighth, ninth, tenth, eleventh, and twelfth cradles 327, 328, 329, 330, 331, and 332, each of which is located in a location corresponding to the seventh, eighth, ninth, tenth, eleventh, and twelfth cradles 117-122. The cradles 327-332 are formed into the inner half 308 of the right side member 303. The cradles are all structurally identical, though there orientation in some cases is flipped.

The first cradle 321 includes a vertical notch extending downward from the top surface terminating a point just above halfway between the top and bottom surfaces. The first cradle 321 terminates in a cavity 333 bound by a socket 337 in the outer half 307. The cavity 33 is blind in the socket 337; it does not pass through the outer half 307. The first cradle 321 is a narrow slot in comparison to the larger cavity 333. The first cradle 321 is oriented vertically, such that a ball assembly is applied from the top down into the first cradle 321.

Each of the cradles depending from the top surface of the framework 300 is identical to the first cradle 321. Each of the third cradle 323, fourth cradle 324, fifth cradle 325, seventh cradle 327, ninth cradle 329, tenth cradle 330, and eleventh cradle 331 depend from the top surface 30. Each has the same cavity 333 as the first cradle 321, and as such, description of each will not be presented here. One having ordinary skill in the art will readily appreciate and understand how such structure is formed and used for the third cradle 323, fourth cradle 324, fifth cradle 325, seventh cradle 327, ninth cradle 329, tenth cradle 330, and eleventh cradle 331.

Further, the second and sixth cradles 322 and 326 have the identical structure as the first cradle 321 as well, but such structure is flipped in orientation about a horizontal. The second and sixth cradles 322 and 326 each have a cavity 333 bound by a socket 337 (shown only in FIG. 5B). Like in the first cradle 321, the slot of the second cradle 112 is formed through the inner half 306 and next to the cavity 333. However, unlike in the first cradle 321, the slot of the second cradle 322 is formed into the framework 300 from the bottom surface of the minor foot 312, and its orientation is thus reversed with respect to the first cradle 321. The sixth cradle 326 is formed and oriented similarly to the second cradle 322, though in the major foot 310 rather than the minor foot 312.

FIGS. 5A-5C illustrate the left side member 302 in a closed position and the right side member 303 in an open position. Just as with the apparatus 10, any of the first through seventh ball assemblies 170, 200, 230, 240, 260, 270, and 280, or any combination of balls from those ball assemblies, may be placed into the apparatus 300 for unique massage arrangement. To open the apparatus so as to remove or apply a ball assembly, each of the left and right side members 302 and 303 is opened. Since FIGS. 5A-5C show the right side member 303 open, the discussion will refer to that element. The inner and outer portions 302 and 303 are pivoted to each other with a vertical hinge 334 at the second end 317 of the right side member 303. The outer half 309 is swung out from the inner half 308, thereby opening the right side member 303 and opening each of the cradles formed therein. Each nut 173 held in one of the cradles in the right side member 303 can thus be removed, freeing that respective end of the ball assembly. The same action is taken with respect to the left side member 302 to entirely free the ball assembly.

To apply a ball assembly, such as the first ball assembly 170 shown in FIG. 5A, to the apparatus 300, the left and right side members 302 and 303 must first be open. The first ball assembly 170 is aligned with the third and ninth cradles 323 and 329, and the nuts 173 of the first ball assembly 170 are placed in the third and ninth cradles 323 and 329, with the shanks 192 carried in the slots of the cradles 323 and 329 formed in the inner halves 306 and 308 of the left and right side members 302 and 303, respectively. The outer halves 307 and 309 are then closed over the inner halves 306 and 308, respectively. When the outer halves 307 and 309 close, the cavities 333 in the sockets 337 of the cradles fit over and contain the heads 193 of the nuts 173 and prevent the nuts 173 from moving vertically or laterally out of the cradles 323 and 329. Further, because the slot of the cradle is smaller than the head 193, the first ball assembly 170 cannot move axially. The inner and outer halves 306 and 307 of the right side member 303 are secured with a clip 335 fit into a catch 336 on the first end 316 of the right side member 303. Similar closure structure is formed on the left side member 302.

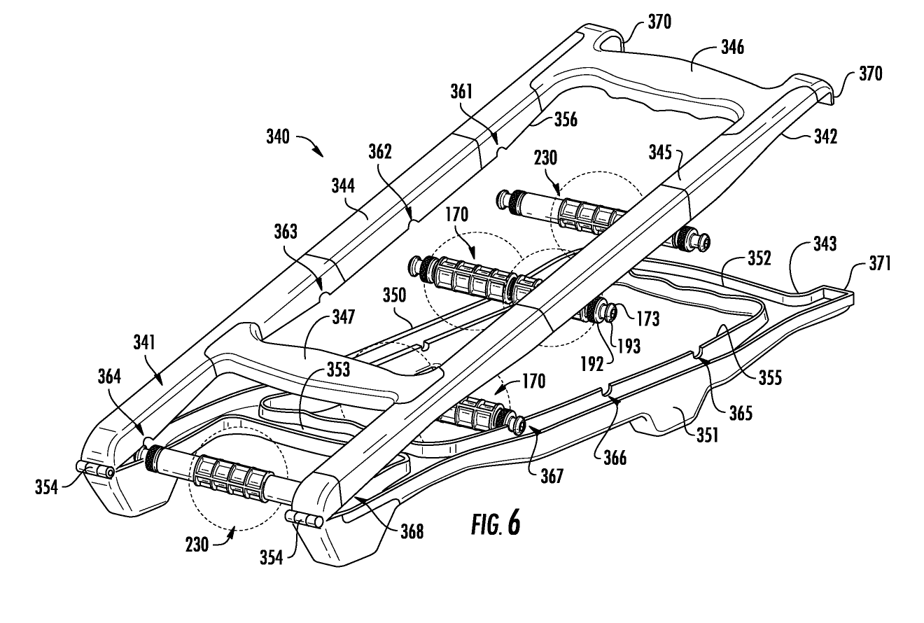

Finally, FIG. 6 shows a third embodiment of a modular self-massage apparatus 340 with an alternate capture means. The apparatus 340 has a clam-shell design that secures any of the first, second, third, fourth, fifth, sixth, and seventh ball assemblies 170, 200, 230, 240, 260, 270, and 280. The apparatus 340 includes a framework 341 bifurcated into an upper portion 342 and a lower portion 343. The upper and lower portions 342 and 343, when closed together, are very similar to the framework 11 of the apparatus 10, with at least the exception of the trigger 22 and the various cradles of that apparatus 10.

The upper portion 342 includes two opposed, elongate left and right side members 344 and 345 and two braces 346 and 347. The braces 346 and 347 space the left and right side members 344 and 345 apart from each other and provide rigidity to the upper portion 342. The braces 346 define grips, or handles, serving not only to space the left and right side members 344 and 345 apart, but also to provide additional gripping and fulcrum locations for an individual. The upper portion 342 is constructed from a material or combination of materials having the material characteristics of low density, high rigidity, high tensile strength, high compressive strength, and durability, such as plastic. The braces 346 and 347 are formed integrally and monolithically to the left and right side members 344 and 345, though in some embodiments, for ease of manufacturing, the braces 346 and 37 are separate pieces fastened to the left and right side members 344 and 345.

The lower portion 343 includes two opposed, elongate left and right side members 344 and 345 and two braces 352 and 353. The braces 352 and 353 space the left and right side members 344 and 345 apart from each other and provide rigidity to the lower portion 343. The braces 352 define grips, or handles, serving not only to space the left and right side members 344 and 345 apart, but also to provide additional gripping and fulcrum locations for an individual. The lower portion 343 is constructed from a material or combination of materials having the material characteristics of low density, high rigidity, high tensile strength, high compressive strength, and durability, such as plastic. The braces 352 and 353 are formed integrally and monolithically to the left and right side members 344 and 345, though in some embodiments, for ease of manufacturing, the braces 352 and 37 are separate pieces fastened to the left and right side members 344 and 345.

The upper and lower portions 342 and 343 cooperate to form the capture means, namely, the several cradles for holding the ball assemblies. The upper and lower portions 342 and 343 are pivoted together at an end with two horizontal hinges 354, thereby allowing the framework 341 to open and close in a clamshell fashion. The lower portion 343 has a continuous internal edge 355 extending along the left and right side members 350 and 351 and the braces 352 and 353. Semi-circular notches are formed downward into the internal edge 355. The upper portion 342 has a similar continuous internal edge 356 extending around its left and right side members 344 and 345 and the braces 346 and 347. Semi-circular notches, corresponding to those formed in the internal edge 355 of the lower portion 343, are formed into the internal edge 356 of the upper portion 342.

These notches cooperate to form cradles. In FIG. 6, the cradles are seen in the open position, and they will be identified with reference to either their notch in the upper portion 342 or lower portion 343. First, second, third, and fourth cradles 361, 362, 363, and 364 are formed between the internal edges 355 and 356 on the left side members 344 and 350. Fifth, sixth, seventh, and eight cradles 365, 366, 367, and 368 are formed between the internal edges 355 and 356 on the right side members 345 and 351. Each of the cradles, when the apparatus 340 is closed, are circular holes defined in the framework 341, having a diameter equal to the shanks 192 of the nuts 173, and smaller than the heads 193 of the nuts 173. Thus, when the apparatus 340 is closed, the heads 193 of the nuts 173 of the ball assemblies cannot are impeded from movement out of the framework, and are thus firmly secured in place.

To apply a ball assembly, such as the first ball assembly 170 shown in FIG. 6, to the apparatus 340, the upper and lower portions 342 and 343 must first be open. The first ball assembly 170 is aligned with the second and sixth cradles 362 and 366, and the nuts 173 of the first ball assembly 170 are placed in the second and sixth cradles 362 and 366, with the shanks 192 carried in the notches of the cradles 362 and 366 formed in the internal edges 355 and 356. The upper portion 342 is then closed down on top of the lower portion 343. When the upper and lower portions 342 and 343 close, the framework 341 fit over and contain the heads 193 of the nuts 173 and prevent the nuts 173 from moving vertically or laterally out of the cradles 362 and 366. The first ball assembly 170 cannot move axially. The upper and lower portions 342 and 343 are secured with two clips 370 fit over two catches 371 on the end of the apparatus 340.

Operation of the apparatus 10 will now be discussed, with the understanding that it applies equally to the apparatus 300 and the apparatus 340. The apparatus 10 is highly modular: each of the ball assemblies can be placed in one of the several sets of cradles, and each ball assembly can be disassembled and reassembled in a different fashion; a large number of combinations of ball assemblies can be created. The disclosure herein has endeavored to describe a representative sample of those different ball assemblies, such as a single ball on an axle, two balls on an axle, a single large ball on an axle, a single ball on an axle offset from the center of the axle, two balls on a single axle with a small gap therebetween, two balls on a single axle with a large gap therebetween, etc. Other permutations are possible with the constituent elements of the balls, the axle, the nuts, and in some cases, the different spacers.

The apparatus 10 in FIG. 1 is shown with a first arrangement, namely, the third ball assembly 230 disposed at the second ends 32 and 52 of the framework 12. The third ball assembly 230 is open on one side, thereby providing an individual with nearly three-hundred and sixty degrees of access to the third ball assembly 230. In this arrangement, an individual can grasp the apparatus 10 with two hands, one on the left side member 14 and the other on the right side member 15, and roll the third ball assembly 230 against a body part. For instance, an individual may so grasp the apparatus 10 with the bottom surface 40 facing himself and with the apparatus 10 in a first end 31-up orientation, so that the third ball assembly 230 is directed downward. This orientation allows an individual to roll the apparatus 10 along the top of his leg in a soothing manner with great control and with the ability to provide a large range in force.

This first arrangement demonstrates another method of holding the apparatus 10. The individual places the brace 20 against the inside of his elbow and grips the brace 21, like a firearm braced inside the arm. The third ball assembly 230 then projects beyond the individual's hand. This allows the individual to provide a large amount of force against his own body. If the individual has selected a ball with a greater hardness, the individual can exert a lot of force and grind into his body, such along the top or sides of the leg. The brace 20 is an efficient fulcrum, disposed against the inside of the elbow, about which that force is applied.

The apparatus 10 in FIG. 1 also shows a second arrangement, namely, two first ball assemblies 170 and 170 carried in cradles proximate to each other. One of the first ball assemblies 170 is seated between the third and ninth cradles 113 and 119, and the other of the first ball assemblies 170 is seated between the fourth and tenth cradles 114 and 120. The first ball assemblies 170 are spaced apart from each other and define a small gap 380 therebetween. The gap 380 is narrow and sized to receive a hand therethrough in direct, compressive contact with each of the first ball assemblies 170. This provides an extremely soothing and therapeutic pressure on the hand as the hand is moved into and out of the gap 380 between the balls 174 of the first ball assemblies 170. If so desired, the individual can replace one of the first ball assemblies 170 with another ball assembly to form a slightly different gap and provide a slightly different massage. For instance, one of the first ball assemblies 170 could be replaced with the third ball assembly 230 having a small, single centered ball 174, or with the sixth ball assembly 270 having a large, single centered ball 274.

In a similar arrangement, the apparatus 10 is configured with a ball assemblies even more closely spaced together. The set of third and ninth cradles 113 and 119 are closer to the set of second and eighth cradles 112 and 118 than to the set of first and sixth cradles 111 and 116. Similarly, the set of first and sixth cradles 111 and 116 is closer to the set of second and eighth cradles 112 and 118 than to the third and ninth cradles 113 and 119. An individual can place, for example, a first ball assembly 170 in the third and ninth cradles 112 and 118 and another first ball assembly 170 in the second and eight cradles 112 and 118 to form a gap smaller than the 380, for even more compressive contact on a hand, or, more preferably, for a massage of just the fingers.

In yet another arrangement, the apparatus 10 is placed on the floor on the major and minor feet 34, 35, 41, and 42. The major and minor feet 34, 35, 41, and 42, with their tacky characteristics, hold the apparatus 10 steady. The individual can then set the ball assemblies in the cradles proximate the top surface 30 as desired, and roll his body against it. For instance, the individual can roll his leg along the apparatus 10. The apparatus 10, with the major and minor feet 34, 35, 41, and 42 firmly planted on the floor, resists movement, sliding, or skidding as the individual rolls his leg along the top of the apparatus 10

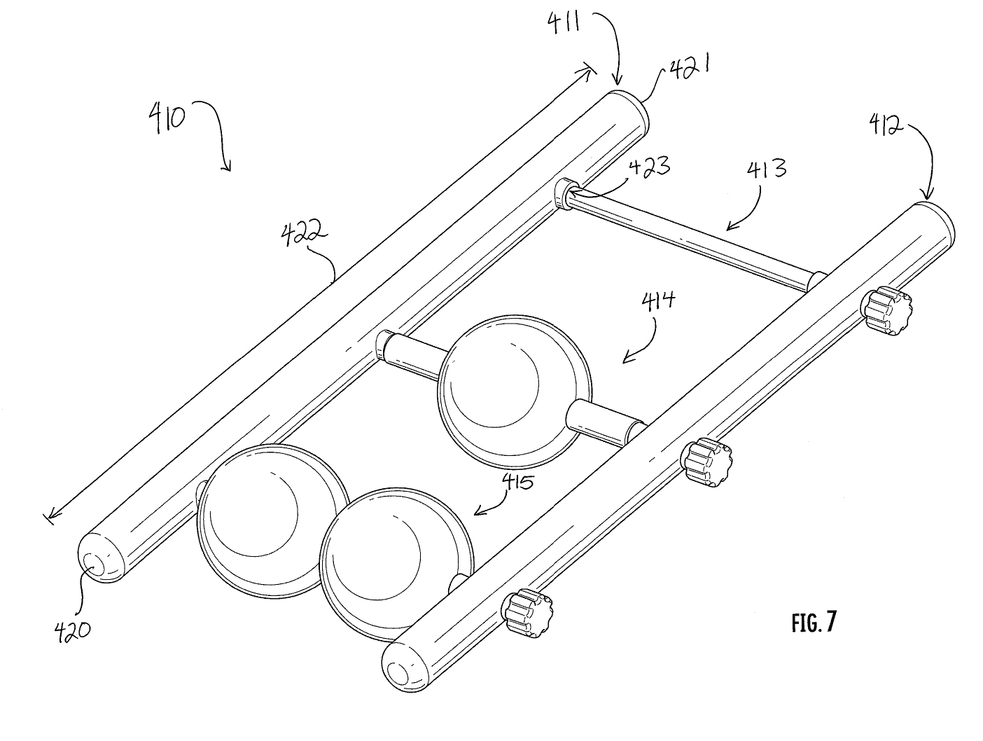

FIGS. 7-26

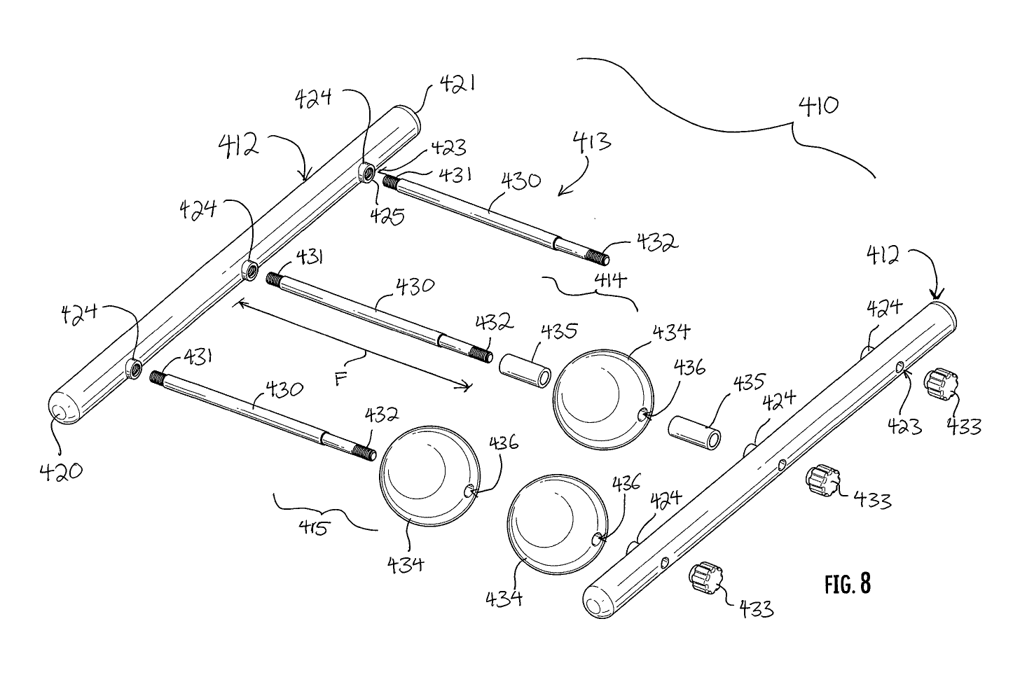

FIGS. 7 and 8 are top perspective and top exploded perspective views, respectively, of an embodiment of a ladder-style modular self-massage apparatus 410 useful for providing soft-tissue and therapeutic relief to individuals. The apparatus 410 allows an individual to give himself a productive, varied, and specific soft massage by providing him with a tool that can be configured in a plurality of disparate arrangements, each defining and allowing a different massage technique, for a different part of the body, with a different type of leverage. The apparatus 410 thus is a unique and effective mechanism for an individual to soothe many different parts of the body with a single tool.

The apparatus 410 includes opposed, separate, spaced-apart first and second side rails 411 and 412 each having opposed ends. The rails 411 and 412 are separate elements separated by a gap, but are nonetheless coupled to each other by three ball assemblies 413, 414, and 415 spanning the gap between the rails 411 and 412. Three ball assemblies 413, 414, and 415 are shown here, but in other embodiments, a lesser or greater number of ball assemblies may be used. Though the ball assemblies are explained in detail later, it is briefly worth noting that the ball assemblies are modular; each can be disassembled and reassembled to form a different type of ball assembly. Modularity is achieved because each ball assembly, while unique, relies on similar or identical constituent parts, such as an axle, a nut, balls, and spacers.

The first and second rails 411 and 412 are nearly identical in every respect except as specifically described below, and as such, only the rail 411 is described here with the understanding that the description applies equally to both rails 411 and 412 but for described exceptions. Indeed, the same reference characters are used to describe structural elements and features that are common to both rails 411 and 412. The rail 411 is elongate, relatively thin, and generally cylindrical, having a circular cross-section. The rail 411 is rigid, constructed of a material or combination of materials such as wood, plastic, or metal. It has opposed first and second ends 420 and 421, and a length 422 extending therebetween. Preferably, three holes 423 are formed entirely through the rail 411, approximately evenly-spaced apart along the length 422 of the rail 411. The holes 423 are closed, entirely enclosed by the rail 411. The axes of orientation through the holes 423 are parallel, so that the holes 423 are arranged in parallel, and, when the ball assemblies 413, 414, and 415 are applied therethrough, they, too, are parallel.

The ball assemblies 413, 414, and 415 are engaged to the rails 411 and 412 at the holes 423. In each rail 411 and 412, hubs 424 are snug fit into the holes 423. The hubs 424 are short, cylindrical projections fit into the holes 423 and projecting laterally out of the holes 423 transverse to the lengths 422 of the rails 411 and 412. The hubs 424 have internally-threaded bores 425 which receive threaded axles of the ball assemblies 413, 414, and 415.

The holes in the first and second rails 411 and 412 are different. In the rail 411, the holes 423 are blind holes. The holes 423 have one open end, as seen in FIGS. 7 and 8, into which the hubs 424 are set. However, in this embodiment of the apparatus 410, the holes 423 do not extend entirely through the rail 411. Rather, they terminate in an endwall short of the outer surface of the rail 411. This defines each hole 423 in the first rail 411 as a blind hole. In the rail 412, however, the holes 423 are through holes. The holes 423 there have two open ends on diametrically opposite sides of the rail 412. The hubs 424 are all set into the holes 423 from the same side, so that they all extend out toward the rail 411.

As is seen in the exploded view of FIG. 8, each ball assembly 413, 414, and 415 includes an axle 430 which extends between the rails 411 and 412. The axles 430 are long, thin, round, and rigid. Each axle 430 has opposed ends 431 and 432 which are threaded. The threaded ends 431 and 432 of the axles 430 threadably engage with the threaded hubs 424 in the rails 411 and 412 to secure the axles 430 between the rails 411 and 412 and to couple the rails 411 and 412 to each other at a fixed distance apart from each other. The ends 431 of the axles 430 that are threaded into the rail 411 terminate in the hubs 424. On the opposing rail 412, however, the ends 432 of the axles 430 are threaded into the hubs 424 and are then also threaded into knurled nuts 433. The nuts 433 are snug fit into the holes 423 and prevent lateral movement of the axles 430 between the rails 411 and 412.

Though all the ball assemblies 413, 414, and 415 have axles 430, each ball assembly 413, 414, and 415 is still different. The ball assembly 413 includes just the axle 430. Like all the ball assemblies, it spans between the opposed rails 411 and 412 and spaces them apart from each other by a fixed distance, denoted by the reference character F, just less than the length of the axle 430 itself. It also provides rigidity to the apparatus 410 across its length between the first and second ends 420 and 421. The ball assembly 413 can be removed from the apparatus 410, disassembled, and reassembled as one of the other ball assemblies 414 and 415 or as a different ball assembly for application into the apparatus 410.

The ball assembly 414 includes the axle 430, the nut 433, a ball 434, and two spacers 435. In some embodiments, the ball 434 is carried on an internal hub to which the ball 434 is formed integrally to during manufacture. In other embodiments, however, the ball 434 is just the ball with a central bore 436 formed therethrough. The ball 434 is a soft, resilient ball, is fairly compressible, and yields under light loads. The ball 434 preferably has a Shore 00 Scale hardness value of less than approximately 64, and more preferably is between approximately 26 and approximately 52. However, other hardness values may be desired for a particular application, and the disclosure of these ranges is not intended to be limiting. The balls 434 shown in the figures have the same outer diameter, but in other embodiments, ball assemblies may have larger or smaller diameters.

The spacers 435 are each long and cylindrical, having ends which are opposed and identical. The spacers 435 each have rotational symmetry about an axis and are symmetric about a central bifurcating plane. The spacers 435 have lengths which are roughly two-thirds the diameter of the ball 434, but, of course, in other embodiments the spacers 435 may be longer or shorter. The spacers 435 have a hollow interior with an inner diameter just larger than the outer diameter of the axles 430, so that the spacers 435 can be fit over the axles 430.

In the ball assembly 414, the spacers 435 are in abutting contact with the ball 434 and space the ball 434 equidistantly from the opposed rails 411 and 412. In other ball assemblies, two spacers 435 may be placed on one side of the ball 434 to place the ball 434 close to one of the rails 411 and 412 or the other. In the ball assembly 414, the spacers 435 interpose the ball 434 and each hub 424, rotating in a plain bearing arrangement with both the ball 434 and the hubs 424.

The ball assembly 415 includes the axle 430, the nut 433, and two balls 434. Here, the balls 434 are in abutting relationship with each other, in direct, plain bearing contact with each other and with the hubs 424 without the spacers 435. The outer diameter of each of the balls 434 is just less than half the length of the axle 430, such that two balls 434 take up the entire length of the axle 430 between the rails 411 and 412, when the axle 430 is threadably engaged with the rails 411 and 412.

To use the apparatus 410, the user assembles the apparatus 410 as shown in FIGS. 7 and 8. The user takes up the rail 411 first, and applies the ends 431 of the axles 430 into the threaded hubs 424 already fit into the rail 411. The user threadably engages the ends 431 therein. With the ball assembly 413, this can be done directly and immediately. With the ball assemblies 414 and 415, the user can perform this step initially and assemble the ball assemblies 414 and 415 later, or can assemble the ball assemblies 414 and 415 first and then apply the ends 431 into the hubs 424 later. Either way, the user applies the ball assemblies 413, 414, and 415 (or some of them) into the rail 411, so that the ends 432 are free. The user can then align the rail 412 with the ends 431 and register each end 431 with one of the bores 425 in the hubs 424. The ends 431 are then threadably engaged with the bores 425 until the ends 431 extend out of the other side of the bores 425, so that the nuts 433 can be threaded thereon.

FIGS. 7 and 8 depict the apparatus 410 in a single arrangement, with the three different ball assemblies 413, 414, and 415. However, the apparatus 410 can be placed in different arrangements: the order of the ball assemblies 413, 414, and 415 may be altered as desired by the user. The user need only unscrew the nut 433 and then unscrew the axles 430 from the rails 411 and 412, remove the particular ball assembly, disassemble it, and then reassemble a new ball assembly and apply it to the apparatus 410. A user may do this to create different hand positions, different compression or massage arrangements, or for other reasons. The ball assemblies shown in these drawings generally show zero, one, or two balls in the ball assemblies; in other embodiments, the ball assemblies may have more balls, and the balls may have correspondingly narrowed diameters to accommodate being packed between the rails, or, conversely, the rails may be spaced further apart to accommodate more than two balls, or two large balls, or three medium-sized balls, etc. Moreover, there may be a lesser or greater number of ball assemblies in the apparatus 410.

Unless otherwise indicated, the remaining drawings illustrate embodiments similar to the apparatus 410. As such, the same reference characters will be used to describe structural elements and features that are common to the apparatus 410 and the embodiment at hand, and it should be understood that such structural elements or features are identical to those described above, unless otherwise indicated, and so no additional disclosure will be made of them. Further, in some instances, various structural elements and features of the embodiments (other than the apparatus 410) will be identical to other elements and features of the embodiments (other than the apparatus 410); in such cases, the same reference characters will be used to indicate the element or feature is the same. Moreover, some common reference characters may be left off the remaining drawings if they are used in other drawings.

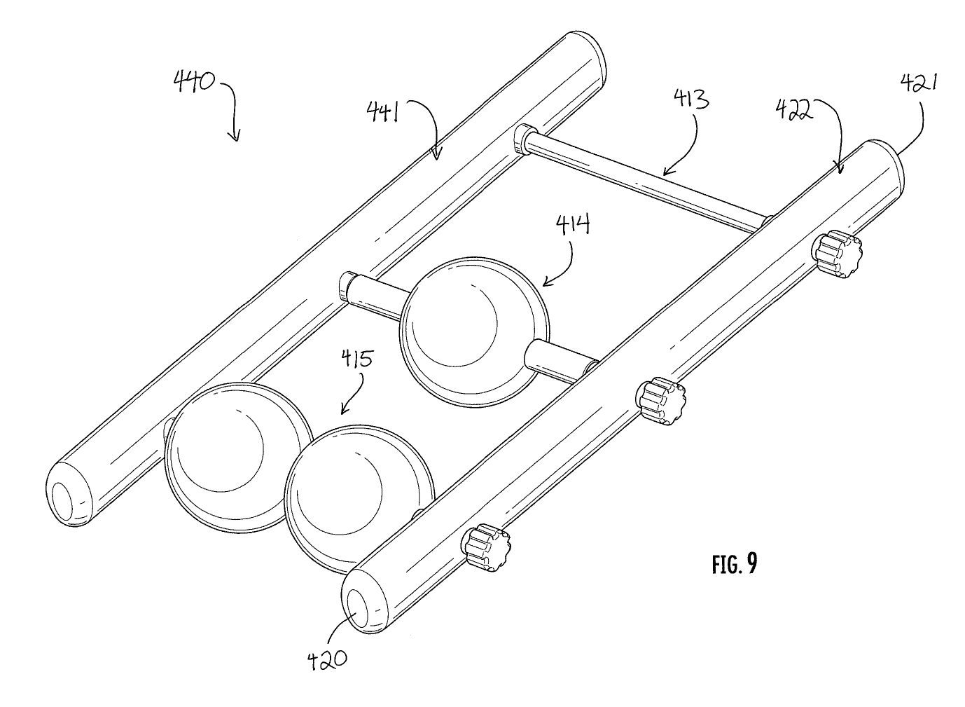

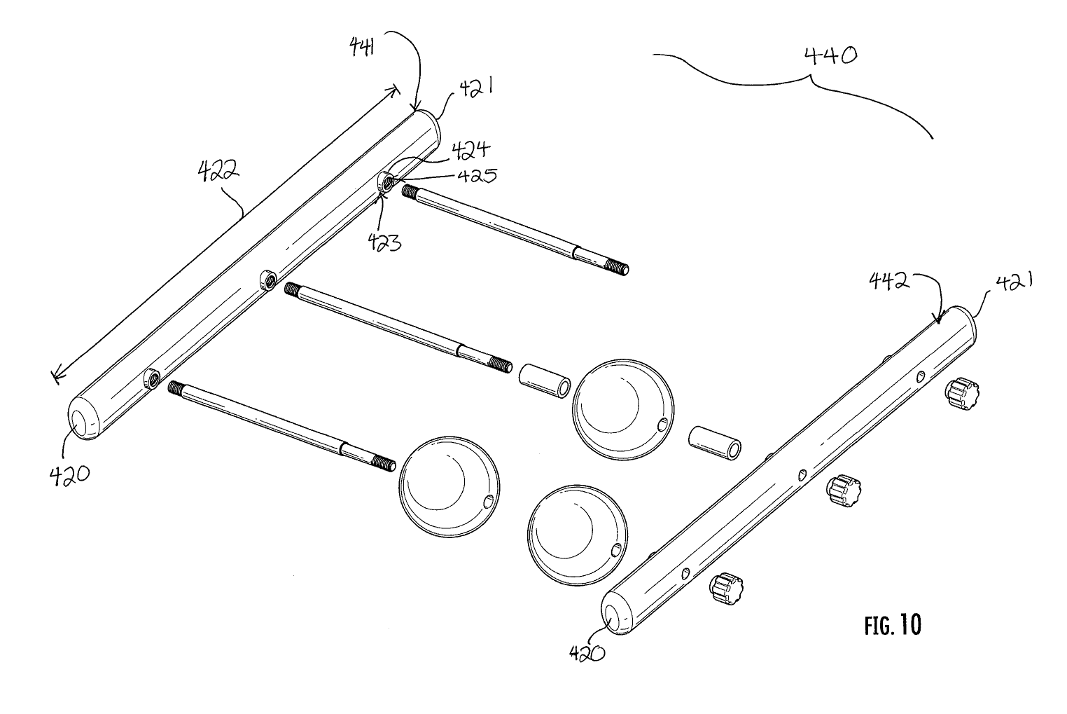

FIGS. 9 and 10 illustrate an embodiment of a ladder-style modular self-massage apparatus 440. The apparatus 440 is identical in every way to the apparatus 410 but for the shape of the rails 441 and 442. The rails 441 and 442 are identical to the rails 411 and 412, respectively, but for the cross-sections. The rails 441 and 442 of the apparatus 440 have an oval cross-section rather than the round cross-section of the rails 411 and 412 of the apparatus 410. Like the rails 411 and 412, however, the rails 441 and 442 have opposed first and second ends 420 and 421, lengths 422, holes 423, hubs 424, and bores 425. The cross-sectional shape of the rails 411 and 412 is not limited to these two embodiments; so long as the rails 411 and 412 are comfortable and rigid during use, any desired cross-sectional shape is suitable.

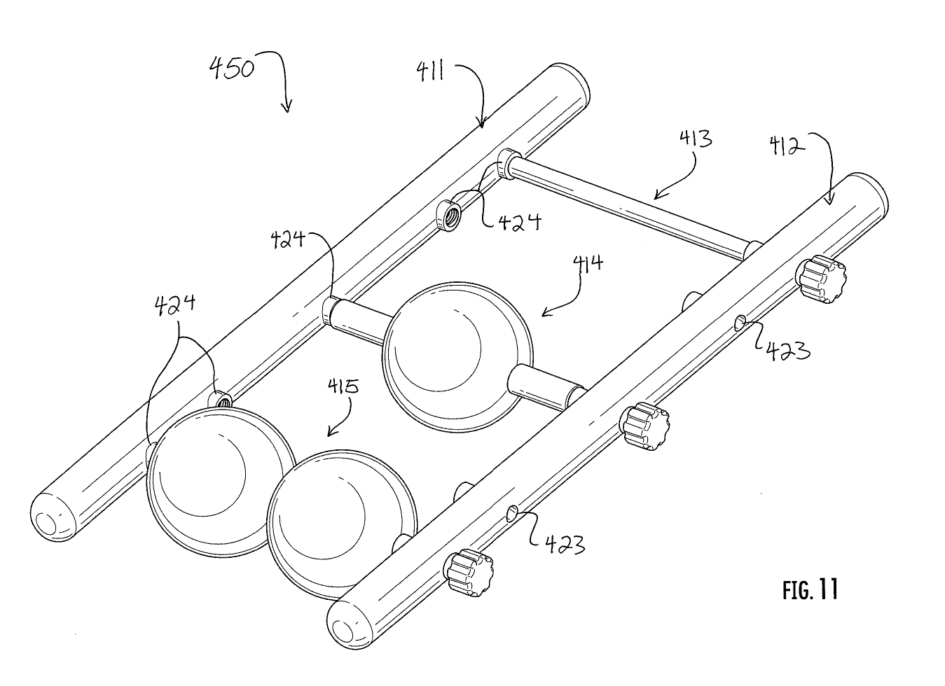

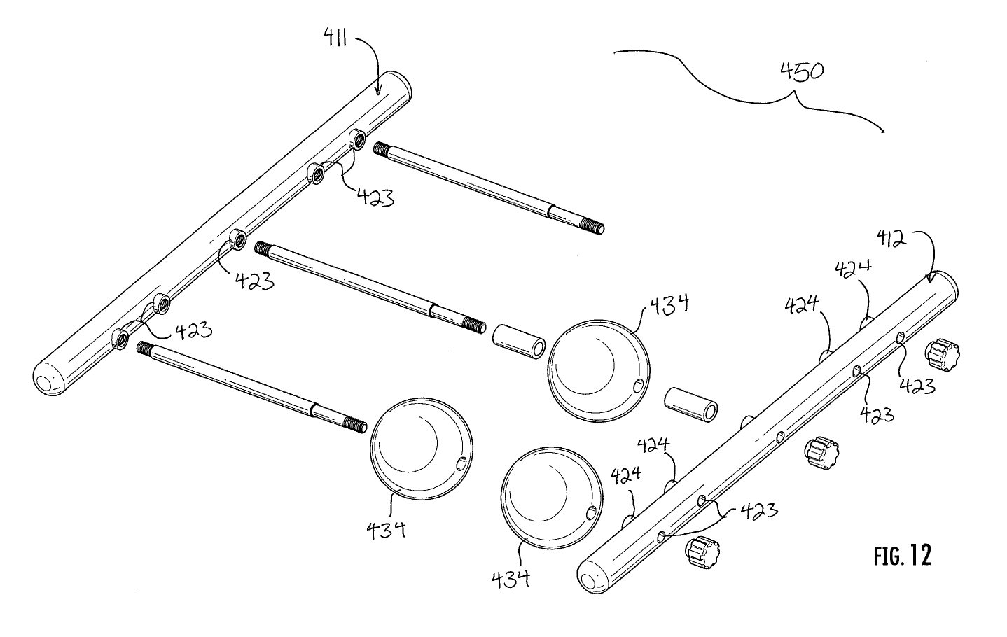

FIGS. 11 and 12 illustrate an embodiment of a ladder-style modular self-massage apparatus 450. The apparatus 450 is identical to the apparatus 410 but for the number of holes 423 and hubs 424, which are here designated with the same reference characters. The rails 411 and 412 are each formed with five holes 423, and five hubs 424 are fitted into them. This allows the apparatus 450 to carry up to five ball assemblies, rather than three as in the apparatus 410. The number of ball assemblies in an apparatus is limited only by the length of the apparatus 450; many holes 423 can be formed in an apparatus to accommodate many different ball assemblies in many different arrangements. Indeed, in all of the embodiments shown in all of the drawings herein, the embodiments may have a lesser or greater number of holes to receive a lesser or greater number of ball assemblies, and the scope of protection should not be limited by the embodiment shown in a particular drawing.

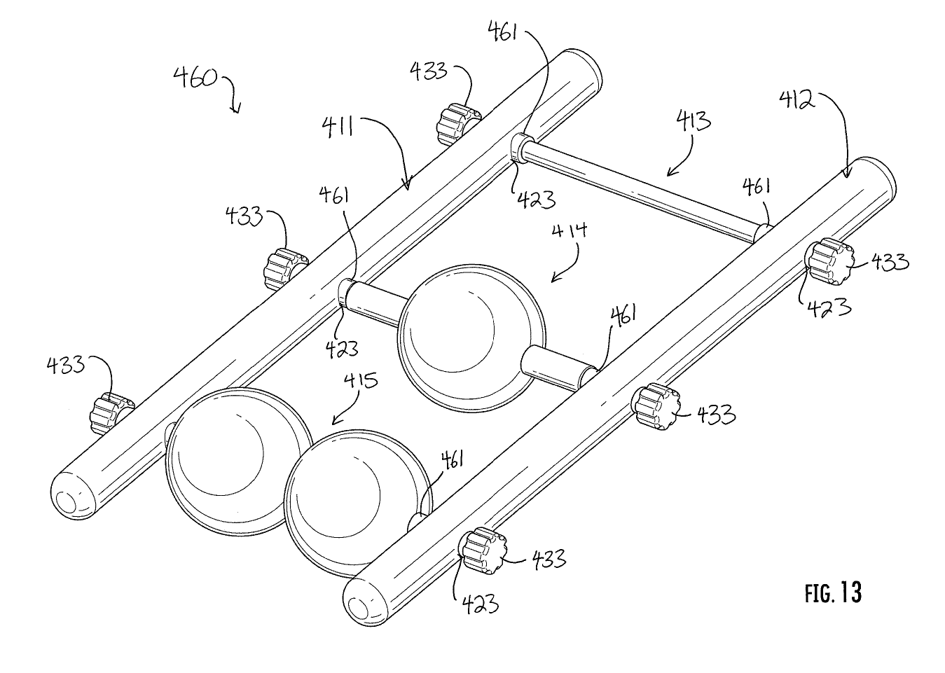

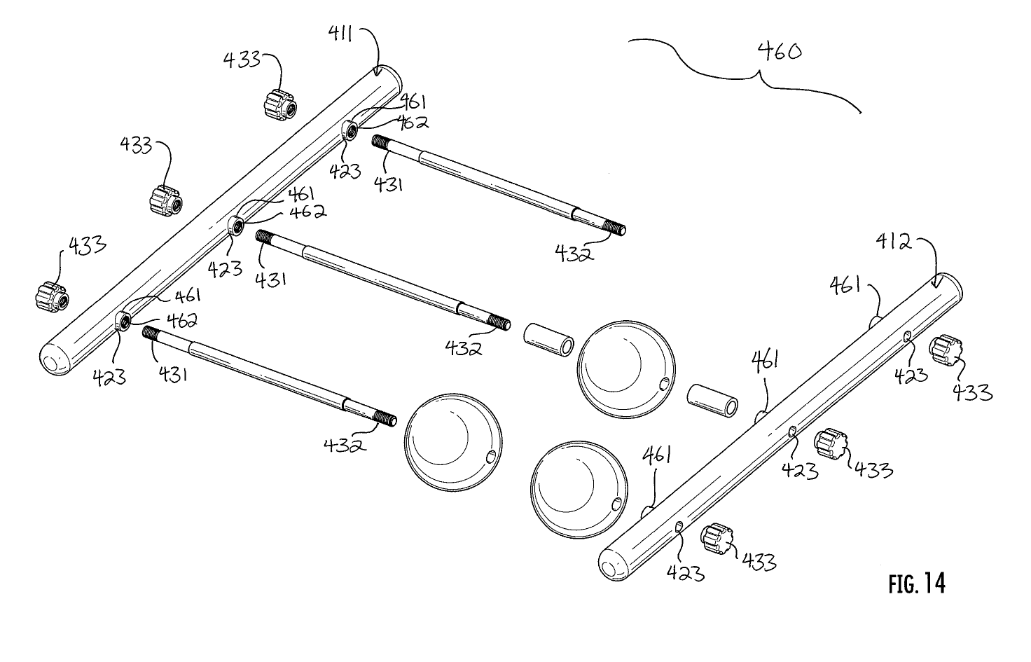

FIGS. 13 and 14 illustrate an embodiment of a ladder-style modular self-massage apparatus 460. The apparatus 460 is very similar to the apparatus 410. However, the holes 423 formed in the rail 411 are through-holes like they are in the rail 412. As such, the apparatus 460 includes an additional set of nuts 433 to engage with the ends 431 of the axles 430 extending through the rail 411. Moreover, unlike the hubs 424 in the apparatus, this embodiment of the apparatus 460 includes hubs 461 which have smooth, unthreaded bores 462. Therefore, the ends 431 and 432 pass through the hubs 461 rather than threadably engage with them. The ends 431 and 432, then extending through the rails 411 and 412, are then secured in the rails 411 and 412 by threadably engaging the nuts 433 onto the threaded ends 431 and 432. This thus prevents the axles 430 from separating from the rails 411 and 412 and secures the first and second rails 411 and 412 on the ball axles 430.

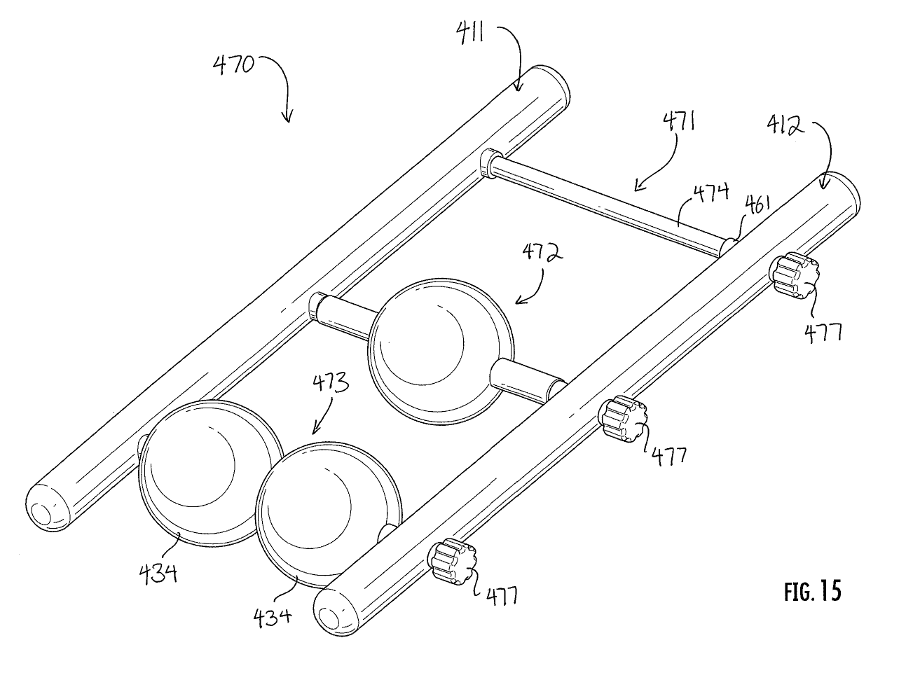

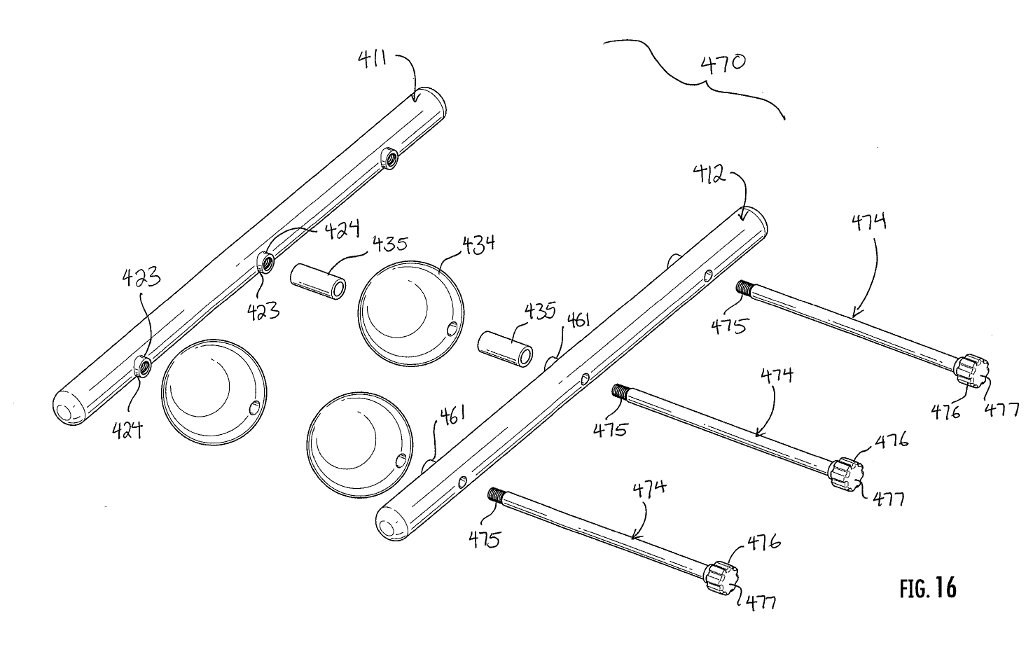

FIGS. 15 and 16 illustrate an embodiment of a ladder-style modular self-massage apparatus 470. The apparatus 470 includes the rails 411 and 412, but the ball assemblies are replaced by ball assemblies 471, 472, and 473, each of which has an axle 474. One end 475 of the axle 474 is formed with threads, like the end 431, but on an opposed end 476 of the axle 474, a nut 477 is formed integrally to the axle 474. The axles 474 still carry the balls 434 and the spacers 435. The axles 474 pass through non-threaded hubs 461 in the rail 412, identical to those in the apparatus 460, and the ends 475 of the axles 474 are then threadably secured in threaded hubs 424 fit into the blind holes 423 in the rail 411. The user need only grasp and rotate the nuts 477 to thread the ends 475 into the hubs 424.

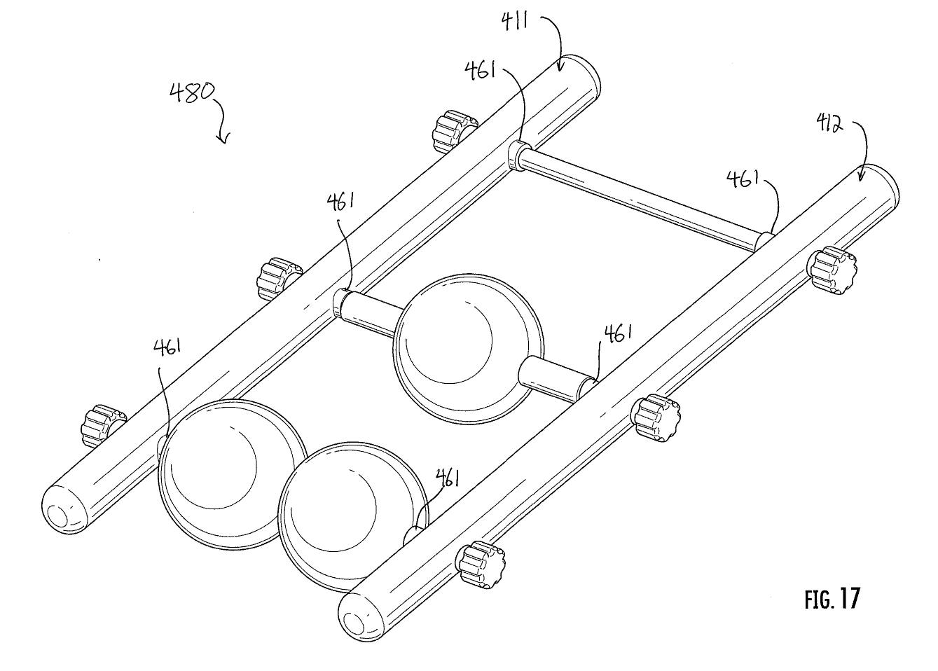

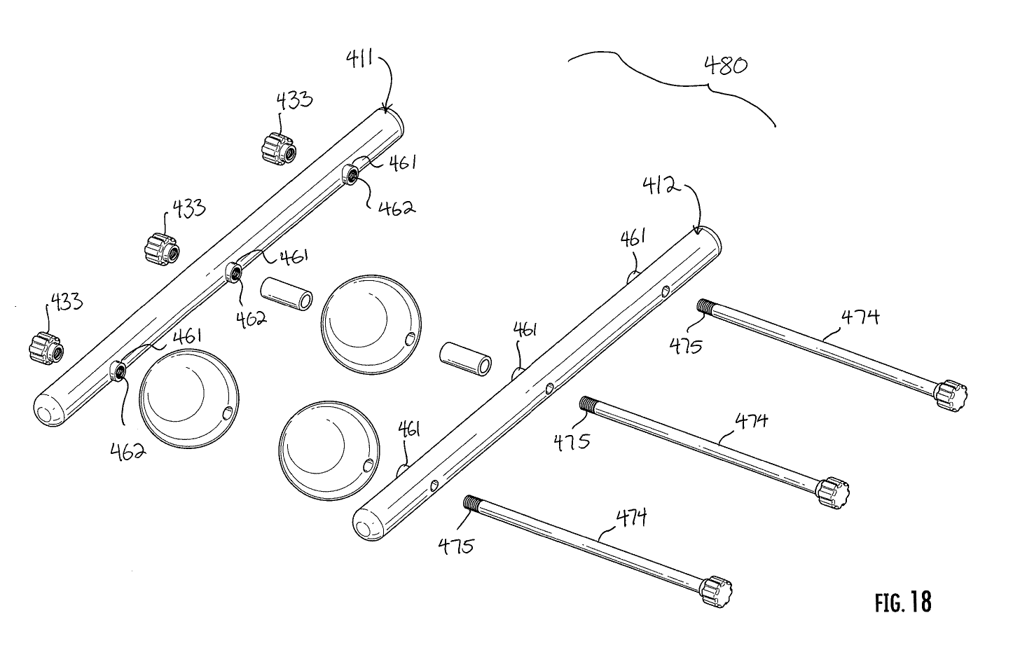

FIGS. 17 and 18 illustrate an embodiment of a ladder-style modular self-massage apparatus 480. The apparatus 480 is identical to the apparatus 470 except that it does not include the threaded hubs 424. Rather, the rails 411 and 412 are both fit with hubs 461 with smooth, unthreaded bores 462 similar to those on the apparatus 460. As such, the threaded ends 475 of the axles 430 pass through the non-threaded hubs 461 in the rail 412 and through the non-threaded hubs 461 in the rail 411. The threaded ends 475 of the axles 474 are then capped by nuts 433 to threadably engage and secure the axles 474.

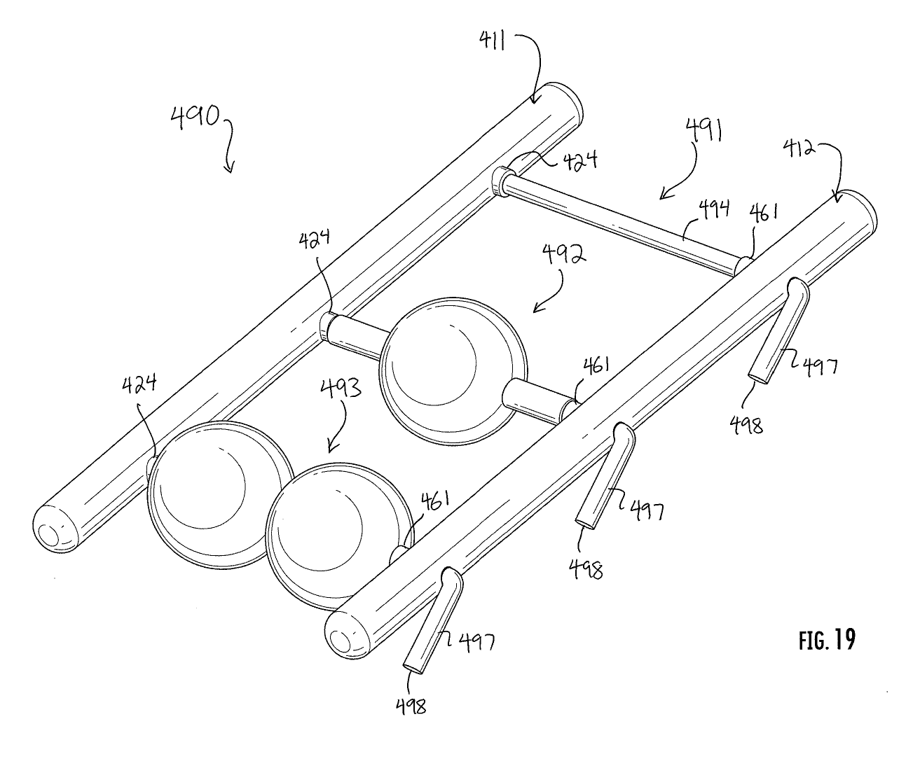

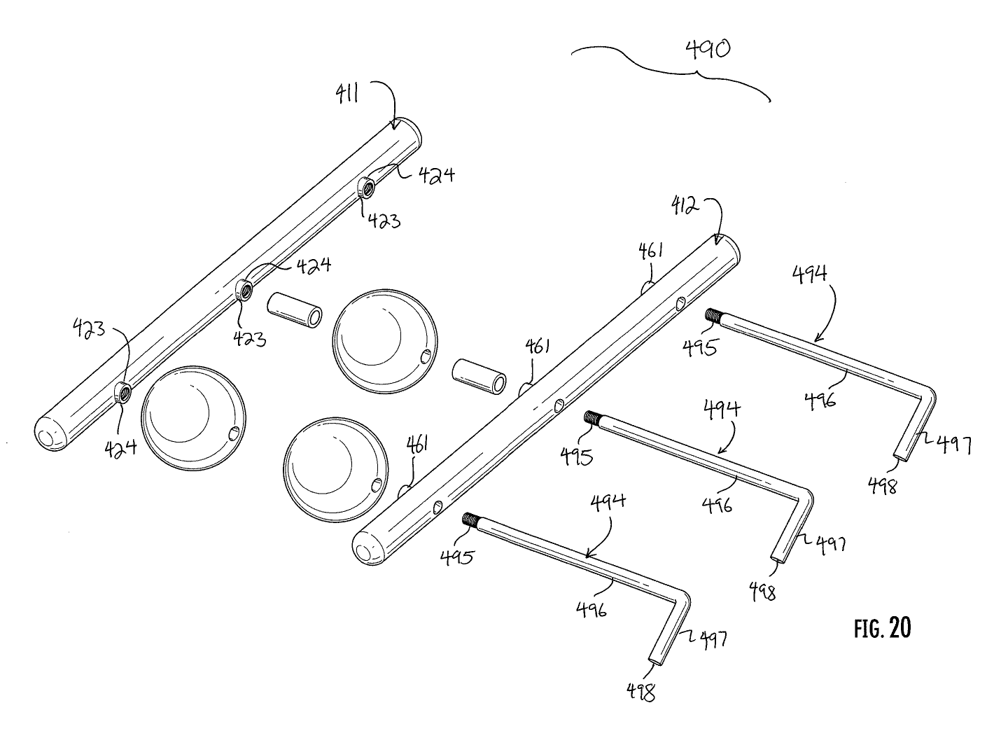

FIGS. 19 and 20 illustrate an embodiment of a ladder-style modular self-massage apparatus 490. The apparatus 490 includes the rails 411 and 412 but has different ball assemblies 491, 492, and 493 with different axles 494 of the ball assemblies are different. The axles 494 are not elongate but are L-shaped. The axles 494 have an end 495, a straight portion 496 extending from the end 495, a bent portion 497 extending transversely at preferably ninety degrees to the straight portion 496, and terminating in an end 498. The bent portion 497 and the end 498 are both smooth and unthreaded, but the opposed end 495 is formed with threads. The ends 495 of the axles 494 are threaded into the threaded hubs 424 set into blind holes 423 in the rails 411. The end of the straight portion 496 proximate to the bent portion 497 is held loosely in a plain bearing fit within the unthreaded hubs 461. The straight portion 496 extends between the first and second rails 411 and 412, and the bent portion 497 extends outside of the second rail 412. The bent portion 497 of the axle 494 prevents the rail 412 from sliding laterally outward off the axle 491.

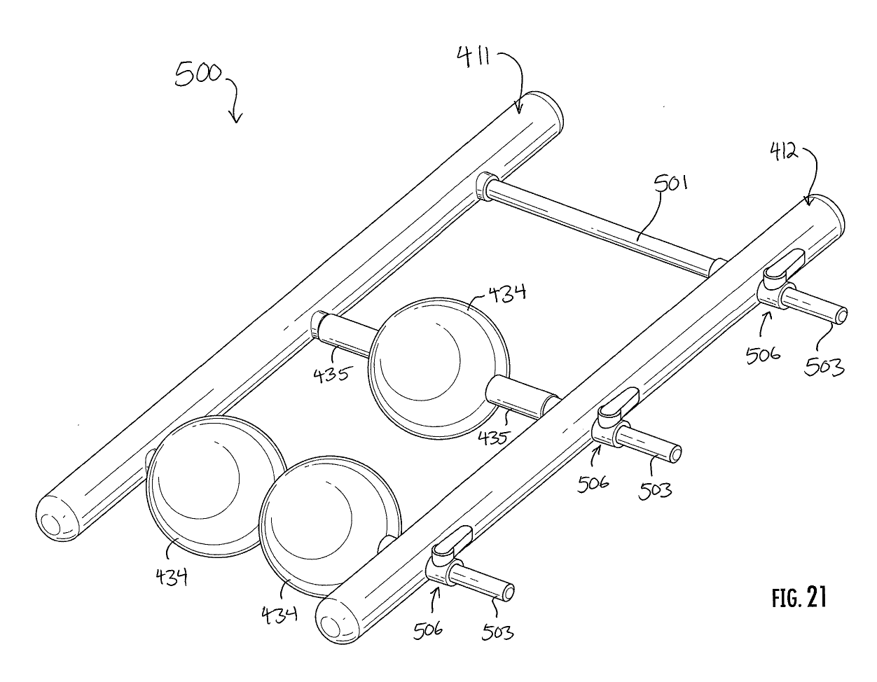

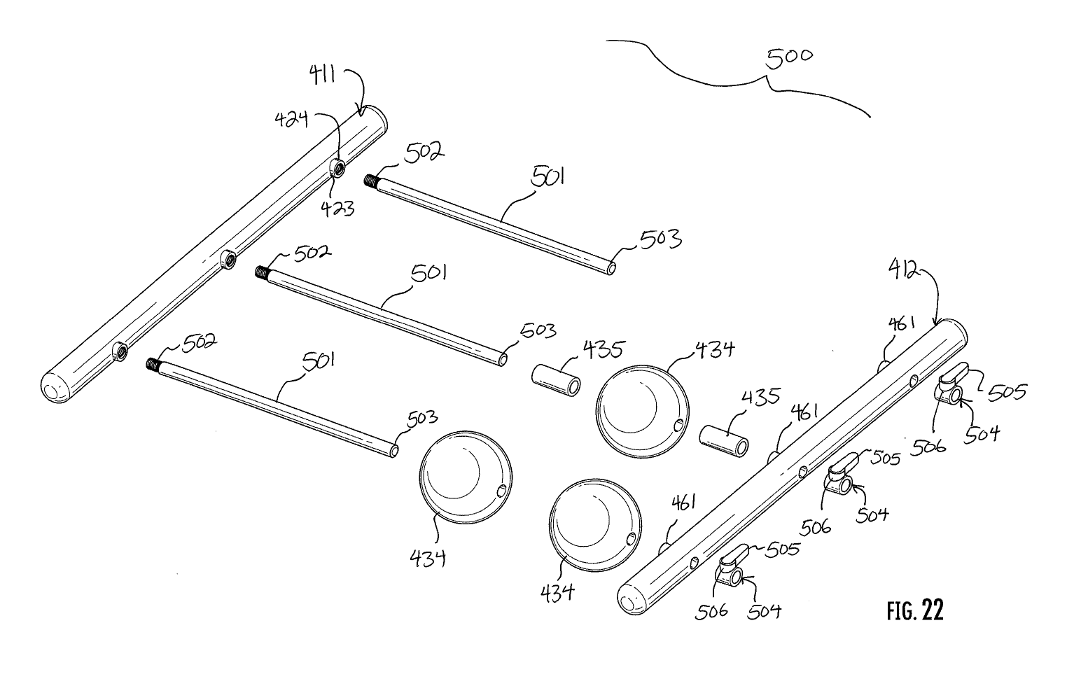

FIGS. 21-22 illustrate an embodiment of a ladder-style modular self-massage apparatus 500. The apparatus 500 is identical in every way to the apparatus 410 but for its axles 501. The axles 501 are long, thin, round, and rigid. Each axle 501 has opposed ends 502 and 503, but the end 502 is threaded and the other end 503 is non-threaded. The threaded ends 502 of the axles 501 threadably engage with the threaded hubs 424 in the blind holes 423 in the rail 411 to secure the axles 501 between the rails 411 and 412 and to couple the rails 411 and 412 to each other. The ends 502 of the axles 501 that are threaded into the rail 411 terminate in the hubs 424 and the holes 423 in which the hubs 424 are fit. On the rail 412, however, the non-threaded ends 503 of the axles 501 are merely passed into the non-threaded hubs 461. The non-threaded ends 502 pass beyond the rail 412, and are fitted with caps 504. The caps 504 are quick-release style caps having a lever 505 that increases and decreases the effective inner diameter of the caps 504. The lever 505 has a post 506 which is upstanding with respect to the cap 504; it extends upwardly from the cap 504 and turns into the lever 505. The post 506 is a cylindrical projection and has an inner end which extends into the cap 504; as the post 506 is rotated, this inner end moves radially into or out of the cap 504 and the interior space it bounds, thereby decreasing or enlarging the effective inner diameter of the cap 504 and thus tightening or loosening the cap 504 on the axle 501. Turning the lever 505 in one direction opens and enlarges the effective inner diameter of the cap 504, while turning it in the other direction closes and narrows the effective inner diameter. In this way, the caps 504 can be slid onto the non-threaded ends 503 of the axles 501 and secured, thereby preventing the axles 501 from sliding within the rail 412.

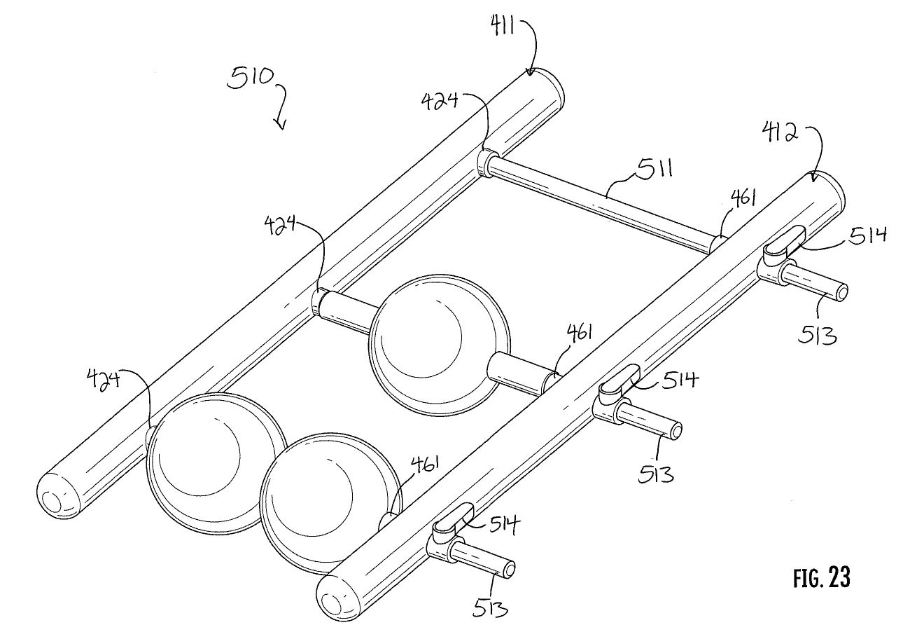

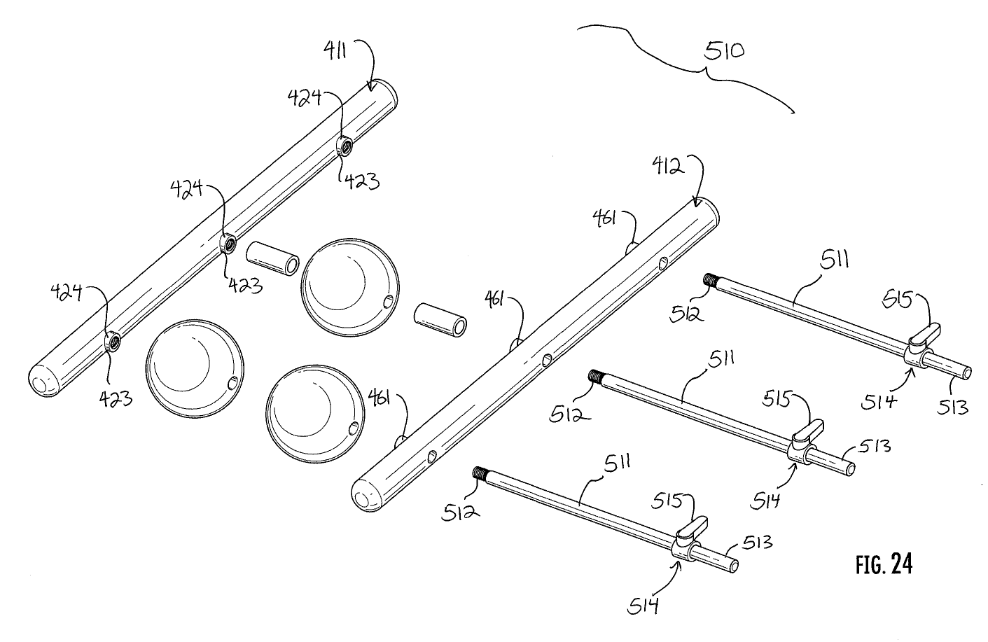

FIGS. 23 and 24 illustrate an embodiment of a ladder-style modular self-massage apparatus 510. The apparatus 510 is identical in every way to the apparatus 500 but for its axles 511. The axles 511 are long, thin, round, and rigid. Each axle 511 has opposed ends 512 and 513, but the end 512 is threaded and the other end 513 is non-threaded and fitted with an integral quick release assembly 514. The threaded ends 512 of the axles 511 threadably engage with the threaded hubs 424 in the blind holes 423 of the rail 411 to secure the axles 511 between the rails 411 and 412 and to couple the rails 411 and 412 to each other. The ends 512 of the axles 511 that are threaded into the rail 411 terminate in the hubs 424 and the holes 423 in which the hubs 424 are fit. On the other rail 412, however, the non-threaded ends 513 of the axles 511 are merely passed into the non-threaded hubs 461 in a loose fit arrangement. The non-threaded ends 513 pass beyond the rail 412 and are then fitted with the quick-release assemblies 514 which can be adjustably slid and set along the length of the axle 511. The quick-release assemblies 514 have a lever 515 that advances or retracts a set screw, clamping down on the axle 511 to prevent movement of the quick-release assembly 514 on the axle 511. Turning the lever 515 in one direction loosens the quick-release assembly 514, while turning it in the other direction tightens the quick-release assembly 514 on the axle 511.

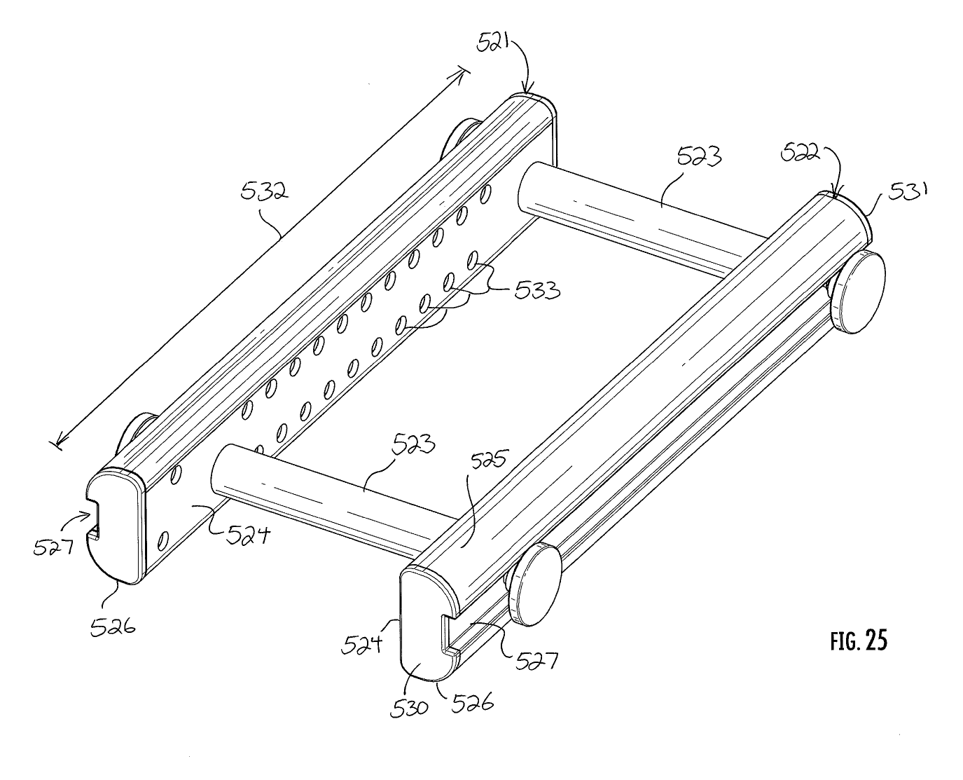

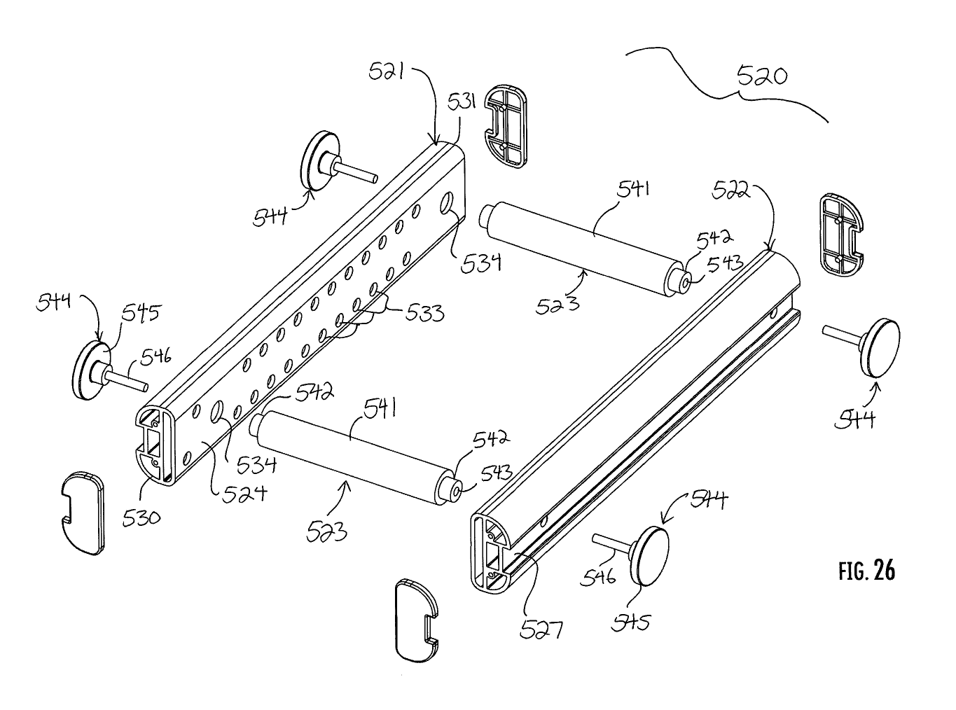

FIGS. 25 and 26 illustrate an embodiment of a ladder-style modular self-massage apparatus 520. The apparatus 520 allows an individual to give him or herself a productive, varied, and specific soft massage by providing him with a tool that can be configured in a plurality of disparate arrangements, each defining and allowing a different massage technique, for a different part of the body, with a different type of leverage. The apparatus 520 thus is a unique and effective mechanism for an individual to soothe many different parts of the body with a single tool.

The apparatus 520 includes spaced-apart first and second side rails 521 and 522 each having opposed ends. In these drawings, the rails 521 and 522 are coupled to each other by two axles 523 spanning the gap between the rails 521 and 522 to space them apart from each other. The drawings do not show use of the apparatus 520 with ball assemblies, and indeed, the axles 523 are different from the axles 430 or the ball assemblies 413, 414, and 415, however, the ball assemblies 413, 414, and 415 could be used with the apparatus 520 in place of the axles 523.

The first and second rails 521 and 522 are identical in every respect except as specifically described below, and as such, only the rail 521 is described here with the understanding that the description applies equally to both rails 521 and 522 but for described exceptions. Indeed, the same reference characters are used to describe structural elements and features that are common to both rails 521 and 522. The rail 521 is elongate, relatively thin, and hollow. It has a corrugated shape including a flat inner face 524, a curved upper 525, a curved lower 526, and an inset channel 527 extending along a length 5232 between the upper 525 and lower 526. The rail 521 is rigid, constructed of a material or combination of materials such as wood, plastic, or metal. It has opposed first and second ends 530 and 531 fit with caps, and the length 532 extending therebetween. A plurality of spaced-apart, small holes 533 are formed through the inner face 524. The small holes 533 only extend through the inner face 524; they do not continue through the upper 525, lower 526, or the channel 527. As such, they are considered blind holes with respect to the rail 411. The holes 533 are arranged in two parallel rows, one proximate to the upper 525 and the other proximate to the lower 526. The axes through these holes 533 are parallel, so that the holes 533 are arranged in parallel, and, when the axles 523 are applied therethrough, they, too, are parallel.

Referring now primarily to FIG. 26, there are also two enlarged holes 534 in the inner face 524; these receive the axles 523. The enlarges holes 534 extend entirely through the inner face 524 and through the inset channel 527, and so are considered through holes with respect to the rail 411. One of the enlarged holes 534 is proximate to the first end 530 and the other is proximate to the second end 531. The holes 534 are each between the two rows of the holes 533. The axles 523 include an integral, central span 540 having a main body 541 and two short posts 542 extending coaxially away from the main body 541. The posts 542 fit snugly into the enlarged holes 534 in the rails 521 and 522. The posts 542 are preferably hollow with an open entrance or socket 543. A cap 544 engages with this socket 543. The cap 544 includes an enlarged head 545 and a shaft 546 extending from the head 545. The cap 544 is fit outside the rails 521 and 522, in juxtaposition with the channel 527, and the shaft 546 passes through the rails 521 and 522 and into the sockets 543, thereby engaging with the axles 523. In some embodiments, the shaft 546 is threaded and threadably engages with the socket 543, while in other embodiments the shaft 546 simply has a snug fit engagement with the socket 543.

When the caps 544 are so engaged with the axles 523, each axle 523 can rotate smoothly with respect to the rails 521 and 522. The caps 544 secure the rails 521 and 522 on the axles and prevent the apparatus 520 from coming apart. The user can thus roll the axles 523 against an injured, sore, or neuropathic body part to provide relief. Alternatively, any of the ball assemblies 413, 414, or 415 can be applied between a pair of opposed holes 533; the ball assemblies 413, 414, and 415 are then captured between the rails 521 and 522 and are available to be rolled against during therapeutic use of the apparatus 520. FIGS. 25 and 26 do not show the ball assemblies 413, 414, and 415 fit in the smaller holes 533, but one having ordinary skill in the art should understand the arrangement from the above description of the ball assemblies 413, 414, and 415 and their use in the various apparatuses described herein.

A preferred embodiment is fully and clearly described above so as to enable one having skill in the art to understand, make, and use the same. Those skilled in the art will recognize that modifications may be made to the description above without departing from the spirit of the invention, and that some embodiments include only those elements and features described, or a subset thereof. To the extent that modifications do not depart from the spirit of the invention, they are intended to be included within the scope thereof.

The invention claimed is:

1. A self-massage apparatus comprising:
opposed first and second rails, each having a first end, an opposed second end, and a length extending therebetween; and
a plurality of ball assemblies having opposed first and second ends, spanning the opposed rails and spacing the first and second rails apart from each other by a fixed distance;
wherein each of the ball assemblies comprises one of:
an axle;
an axle, a ball mounted on the axle, and spacers flanking the ball; and
an axle and balls mounted on the axle.

2. The self-massage apparatus of claim 1, wherein the first and second rails are separate.

3. The self-massage apparatus of claim 1, wherein:
the first end of each ball assembly is received in a blind hole formed in the first rail, and the second end of each ball assembly is received in a through hole formed in the second rail; and
nuts are threaded onto the second end of each ball assembly to secure the second rail on the ball assembly.

4. The self-massage apparatus of claim 3, wherein the first and second rails each have circular cross-sections.

5. The self-massage apparatus of claim 3, wherein the first and second rails each have oval cross-sections.

6. The self-massage apparatus of claim 1, wherein:
the first end of each ball assembly is received in a through hole in the first rail, and the second end of each ball assembly is received in a through hole formed in the second rail; and
nuts are threaded onto the first and second ends of each ball assembly to secure the first and second rails on the ball assemblies.

7. The self-massage apparatus of claim 1, wherein, in each ball assembly:
the axle has opposed first and second ends;
the first end of the axle is threadably received in a blind hole in the first rail and the second end of the axle is received in a through hole in the second rail; and
a nut is integrally formed to the second end of the axle and prevents the second rail from moving off the axle proximate to the second end.

8. The self-massage apparatus of claim 1, wherein, in each ball assembly:
the axle has opposed first and second ends;
the first end of the axle is received in a through hole in the first rail, and the second end of the axle is received in a through hole formed in the second rail;
a nut is threaded onto the first end of the axle to secure the ball assembly in the first rail; and
a nut is integrally formed to the second end and prevents the second rail from moving off the axle proximate the second end.

9. The self-massage apparatus of claim 1, wherein the axle includes a straight portion and a bent portion extending transversely with respect to the straight portion, wherein the straight portion extends between the first and second rails, and the bent portion extends outside of the second rail.

10. The self-massage apparatus of claim 1, wherein:
the axle has opposed first and second ends;
the first end of the axle is threadably received in the first rail; and
the second end of the axle carries a cap with a lever for increasing and decreasing an effective inner diameter of the cap, so as to tighten and loosen the cap on the second end of the axle.

11. A self-massage apparatus comprising:
opposed and separate first and second rails, each having a first end, an opposed second end, and a length extending therebetween; and
a plurality of ball assemblies having opposed first and second ends, spanning the opposed rails, engaged with each of the first and second rails, and spacing the first and second rails apart from each other by a fixed distance;
wherein each of the ball assemblies comprises one of:
an axle;
an axle, a ball mounted on the axle, and spacers flanking the ball; and
an axle and balls mounted on the axle.

12. The self-massage apparatus of claim 411, wherein:
the first end of each ball assembly is received in a blind hole formed in the first rail, and the second end of each ball assembly is received in a through hole formed in the second rail; and
nuts are threaded onto the second end of each ball assembly to secure the second rail on the ball assembly.

13. The self-massage apparatus of claim 412, wherein the first and second rails each have circular cross-sections.

14. The self-massage apparatus of claim 412, wherein the first and second rails each have oval cross-sections.

15. The self-massage apparatus of claim 411, wherein:
the first end of each ball assembly is received in a through hole in the first rail, and the second end of each ball assembly is received in a through hole formed in the second rail; and
nuts are threaded onto the first and second ends of each ball assembly to secure the first and second rails on the ball assembly.

16. The self-massage apparatus of claim 411, wherein, in each ball assembly:
the axle has opposed first and second ends;
the first end of the axle is threadably received in a blind hole in the first rail and the second end of the axle is received in a through hole in the second rail; and
a nut is integrally formed to the second end of the axle and prevents the second rail from moving off the axle proximate to the second end.

17. The self-massage apparatus of claim 411, wherein, in each ball assembly:
the axle has opposed first and second ends;
the first end of the axle is received in a through hole in the first rail, and the second end of the axle is received in a through hole formed in the second rail;
a nut is threaded onto the first end of the axle to secure the ball assembly in the first rail; and
a nut is integrally formed to the second end and prevents the second rail from moving off the axle proximate the second end.

18. The self-massage apparatus of claim 411, wherein the axle includes a straight portion and a bent portion extending transversely with respect to the straight portion, wherein the straight portion extends between the first and second rails, and the bent portion extends outside of the second rail.

19. The self-massage apparatus of claim 411, wherein:
the axle has opposed first and second ends;
the first end of the axle is threadably received in the first rail; and
the second end of the axle carries a cap with a lever for increasing and decreasing an effective inner diameter of the cap, so as to tighten and loosen the cap on the second end of the axle.

20. A self-massage apparatus comprising:
opposed first and second rails, each having a first end, an opposed second end, and a length extending therebetween;
each of the first and second rails includes:
a flat inner face directed toward the flat inner face of the other of the first and second rails;
a curved upper, a curved lower, and an inset channel extending along the length between the curved upper and lower;
a plurality of blind holes arranged in two rows on the inner faces of the first and second rails; and
two through holes formed through the first and second rails, proximate to the first and second ends;
two axles spanning the opposed rails, engaged with each of the first and second rails, and spacing the first second rails apart from each other; and
caps engaged with the axles, securing the first and second rails on the axles.
